(19) United States
(12) Patent Application Publication
(10) Pub. No.: US 2023/0010693 A1
(43) Pub. Date: Jan. 12, 2023

(54) Extractor Insert with Bidirectional Driving Capability and Corresponding Extractor Insert Set with Intermediate Sizes

(71) Applicant: Apex Brands, Inc., Apex, NC (US)

(72) Inventors: Zhihong Fu, Cary, NC (US); Jesse Higgins, Raleigh, NC (US)

(21) Appl. No.: 17/950,309

(22) Filed: Sep. 22, 2022

Related U.S. Application Data
(63) Continuation-in-part of application No. 16/204,134, filed on Nov. 29, 2018.
(60) Provisional application No. 62/598,005, filed on Dec. 13, 2017.

(51) Int. Cl. B25B 13/06; B25B 21/00

(52) U.S. Cl. CPC B25B 13/06; B25B 21/00

(57) ABSTRACT

A extractor insert may a body and a securing lip. The body may have a fastener engagement recess. The securing lip may extend radially away from a central axis beyond an exterior of the body. The fastener engagement recess may be an internal channel through the body and is open at a driven end and a drive end. Engagement ribs may extend from internal sidewalls of the body towards the central axis, and each engagement rib may include an apex that extends along a length of the engagement rib. Each engagement rib may have an opposing engagement rib such that apexes of the opposing engagement ribs may be disposed on a common plane with the central axis. Further, each apex may taper at a taper angle such that a distance between apexes of opposing engagement ribs is largest at the drive end and smallest at the driven end.

### CROSS REFERENCE TO RELATED APPLICATION

This application is a continuation-in-part of U.S. application number 16/204,134 filed Nov. 29, 2018, which claims priority to U.S. application number 62/598,005 filed Dec. 13, 2017, the entire contents of which are hereby incorporated by reference in their entirety.

### TECHNICAL FIELD

Example embodiments generally relate to rotating tools and, in particular, relate to a socket or insert tools that are configured to enable driving of fastening nuts or other drivable components in either direction, along with a set of such sockets or inserts that includes intermediate sizes.

### BACKGROUND

Socket tools, such as socket wrenches, are familiar tools for fastening nuts, bolts, and other drivable components or fasteners. The sockets of these tools are commonly removable heads that interface with the ratchet, socket wrench, or other driver on one side and interface with one of various different sizes of nut, bolt head, or other fastener on the other side. Because high torque is often applied through these tools, and high strength and durability is desirable, the sockets are traditionally made of a metallic material such as iron or steel.

Similarly, inserts are also used in association with a driving device, such as a hand wrench, e.g., box wrench, nut driver, or other driving tools for fasting nuts, bolts, and other drivable components to fasteners. Such inserts may operate as intermediate components between a driving tool and a fastener to act upon the fastener. The inserts may be interchangeable to allow the same driving tool to be utilized for operating on a variety of fasteners. Similar to a socket, an insert may be subjected to high torque and are therefore often made of a metallic material such as iron or steel.

Sockets and inserts are generally made in sets that include different sized engaging recesses for each common size of fastener, where the fastener fits within the recess. The corresponding recess size for each common size of fastener is often the best tool that can be used to drive the fastener in either the tightening or loosening direction. In this regard, the shape of the engaging recess and fastening nut or fastener head is matched (e.g., typically hexagonal in shape), and the sizes are also very closely matched to ensure maximum surface contact and therefore even distribution of force to all of the faces of the fastening nut or fastener head. However, if the wrong size of engaging recess is used, or if an adjustable wrench or plier is used, the forces may be concentrated on the corners of the fastening nuts (i.e., the transitions between the adjacent faces that form the familiar hexagonal shape). These concentrated forces can damage or strip the corners of the fastening nut or fastener head so that the corners become rounded. When the corners become sufficiently rounded, traditional sockets will slip when a significant force is applied or the socket may even be rendered useless and no longer be able to grip the fastener sufficiently to move it one or both directions. The risk of rounding can be exacerbated when fasteners are exposed to water, harsh chemicals, or other environments that can rust or corrode the fastener nut or head.

Once a fastener is rounded, a conventional wrench or other driving tool may no longer be usable to either remove the fastener or further tighten the fastener. Accordingly, a fastener extraction device may be used to, for example, remove the fastener. Although numerous designs of bolt extraction devices have been proposed, conventional designs are unidirectional. In this regard, these designs are generally tailored only for removal of the damaged fastener, and have no capability to drive a fastener (much less a damaged fastener). Thus, these designs assume that the best or only way to extract the fastener is to turn it in a single direction (i.e., the counterclockwise direction). Alternatively or additionally, these designs assume that the operator can replace the damaged fastener with a new (undamaged) fastener after removal of the damaged fastener. However, there are many instances where it is necessary to use the same (i.e., damaged) fastener that was removed. Moreover, there may also be situations where nuts are threaded on bolts in such a way that the extraction direction is actually clockwise instead of counterclockwise. Finally, it is also possible that driving the damaged fastener in the clockwise direction (or counterclockwise direction) is advantageous prior to driving the damaged fastener in the counterclockwise direction (or clockwise direction). In other words, in some cases, a directional change may facilitate driving of the damaged fastener in any direction. Additionally, in some cases, the stripping of a fastener may be so severe that even conventional unidirectional extraction devices are not capable of gripping the fastener and merely rotate around the fastener without moving it.

Thus, it may be desirable to provide a new design for an extractor socket or insert and an extractor socket set or insert set with improved performance, including a capability for bidirectionally gripping, driving, and removing fasteners, including severely rounded, corroded, or damaged fasteners.

### BRIEF SUMMARY OF SOME EXAMPLES

According to some example embodiments, an extractor insert having a driven end and a drive end is provided. The extractor insert may comprise a body and a securing lip. The body may extending along a central axis of the extractor insert and may comprise a fastener engagement recess and a drive surface assembly. The securing lip may be coupled to the body at the driven end. The securing lip may also extend radially away from the central axis such that the securing lip extends beyond an exterior of the body. The drive surface assembly may comprise a plurality of external engaging surfaces configured to interface with a driving tool to permit a rotational force to be applied to the extractor insert. The fastener engagement recess may be an internal channel through the body extending along the central axis that is open at the driven end and the drive end. The fastener engagement recess may be defined by internal sidewalls of the body. A plurality of engagement ribs may extend from the internal sidewalls of the body towards the central axis. Each engagement rib may comprise an apex that extends along a length of the engagement rib, and each engagement rib may have an opposing engagement rib such that apexes of opposing engagement ribs are disposed on a common plane with the central axis. Further, each apex may taper at a taper angle relative to the central axis such that a distance between apexes of opposing engagement ribs is largest at the drive end and smallest at the driven end.

According to some example embodiments, a set of extractor inserts is provided. The set of extractor inserts may comprise a first insert, a second insert, and an intermediate insert. The first insert may have a first insert fastener engagement recess configured to receive a first standard size of fastener for driving of the first standard size of fastener. The second insert may have a second insert fastener engagement recess configured to receive a second standard size of fastener for driving of the second standard size of fastener. The intermediate insert may have an intermediate insert fastener engagement recess configured to receive a fastener between the first and second standard sizes of fastener.

According to some example embodiments, an extraction system is provided. The extraction system may comprise a wrench comprising a drive opening having an opening height defined by a top side and a bottom side of the wrench and an opening width. The extraction system may also comprise an extractor insert. The extractor insert may comprise a body and a securing lip. The body may comprise a fastener engagement recess that extends through the body. The body and the fastener engagement recess may extend along a central axis from a drive end that receives a fastener into the fastener engagement recess to a driven end of the extractor insert. The securing lip may radially extend away from the body and away from the central axis at the drive end. A plurality of tapered engagement ribs may extend into the fastener engagement recess from internal sidewalls of the body towards the central axis. Each tapered engagement rib may comprise an apex that extends along a length of the tapered engagement rib. Each tapered engagement rib may have an opposing tapered engagement rib such that apexes of the opposing tapered engagement ribs are disposed on a common plane with the central axis. The securing lip may define a securing lip width through the central axis and the body may defines a body width through the central axis. The securing lip width may be larger than the body width. The extractor insert may be removably engaged with the drive opening of the wrench such that a portion of the body of the extractor insert is disposed within the drive opening and the securing lip rests on an extractor insert engaging edge of the drive opening on the top side of the wrench. The portion of the body disposed within drive opening may extend into the drive opening a distance that is less than the opening height such that the body does not extend beyond the bottom side of the wrench when the securing lip is rested on the top edge of the drive opening.

### BRIEF DESCRIPTION OF THE SEVERAL VIEWS OF THE DRAWING(S

Having thus described some example embodiments in general terms, reference will now be made to the accompanying drawings, which are not necessarily drawn to scale, and wherein:

FIG. 1A illustrates a perspective view of a drive end of an extractor socket according to an example embodiment;

FIG. 1B illustrates a perspective view of a driven end of the extractor socket according to an example embodiment;

FIG. 2A illustrates a drive end of the extractor socket with a fastener received therein according to an example embodiment;

FIG. 2B illustrates a driven end of the extractor socket according to an example embodiment;

FIG. 2C illustrates a top view of a fastener according to an example embodiment;

FIG. 3A illustrates a side view of the extractor socket according to an example embodiment;

FIG. 3B illustrates a cross section view of the extractor socket taken along the axis of the extractor socket according to an example embodiment;

FIG. 4 illustrates a set of extractor sockets according to an example embodiment;

FIG. 5 illustrates a chart of size characteristics of various extractor sockets in a set of extractor sockets according to an example embodiment;

FIG. 6 illustrates an extractor socket set according to an example embodiment;

FIG. 7A illustrates a perspective view of a first type of an extractor socket according to an example embodiment;

FIG. 7B illustrates a perspective view of a second type of an extractor socket according to an example embodiment;

FIG. 7C illustrates a perspective view of a third type of an extractor socket according to an example embodiment;

FIG. 8A illustrates a top view, side cross section view, and bottom view of the first type of an extractor socket according to an example embodiment;

FIG. 8B illustrates a top view, side cross section view, and bottom view of the second type of an extractor socket according to an example embodiment;

FIG. 8C illustrates a top view, side cross section view, and bottom view of the third type of an extractor socket according to an example embodiment;

FIG. 9 illustrates a side cross section view of an extractor socket illustrating the tapered fastener engagement recess according to an example embodiment;

FIG. 10A illustrates a top view of an extractor socket illustrating the changes in diameter of the tapered fastener engagement recess according to an example embodiment;

FIG. 10B illustrates a close up view of the apex of an engagement rib according to an example embodiment;

FIG. 11 illustrates a chart of size characteristics of various extractor sockets in a set of extractor sockets depicted in FIG. 6-10B according to an example embodiment;

FIG. 12A illustrates a perspective top or drive end view of an extractor insert according to some example embodiments;

FIG. 12B illustrates a perspective bottom or driven end view of an extractor insert according to some example embodiments;

FIG. 12C illustrates a drive end view of an extractor insert according to some example embodiments;

FIG. 12D illustrates a first side view of an extractor insert according to some example embodiments;

FIG. 12E illustrates a second side view of an extractor insert according to some example embodiments;

FIG. 12F illustrates a driven end view of an extractor insert according to some example embodiments;

FIG. 12G illustrates a cross-section view of an extractor insert taken at A-A of FIG. 12C according to some example embodiments;

FIG. 13 illustrates an example set of extractor inserts according to some example embodiments;

FIG. 14A illustrates an example driving tool according to some example embodiments;

FIG. 14B illustrates an extractor insert installed in the example driving tool of FIG. 14A according to some example embodiments;

FIG. 15 illustrates a chart of size characteristics of various extractor inserts in a set of extractor inserts according to some example embodiments;

FIG. 16A illustrates a top view of an extractor insert including a first indicia according to some example embodiments;

FIG. 16B illustrates a top view of an extractor insert including a first indicia according to some example embodiments;

FIG. 17A illustrates a top side view of a wrench with the extractor insert disposed in a drive opening of a box wrench end of the wrench according to some example embodiments;

FIG. 17B illustrates zoomed top side view of the box wrench end of the wrench with the extractor insert disposed in the drive opening of the box wrench end according to some example embodiments;

FIG. 17C illustrates zoomed side view of the box wrench end of the wrench with the extractor insert disposed in the drive opening of the box wrench end according to some example embodiments;

FIG. 17D illustrates a bottom side view of the wrench with the extractor insert disposed in the drive opening of the box wrench end according to some example embodiments;

FIG. 17E illustrates zoomed bottom side view of the box wrench end of the wrench with the extractor insert disposed in the drive opening of the box wrench end;

FIG. 17F illustrates zoomed bottom side perspective view of the box wrench end of the wrench with the extractor insert disposed in the drive opening of the box wrench end according to some example embodiments; and

FIG. 17G illustrates cross-section side view of the box wrench end of the wrench with the extractor insert disposed in the drive opening of the box wrench end taken at B-B of FIG. 17B according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of bidirectional extractor socket head, and a socket set including a plurality of such bidirectional extractor socket heads that include intermediate sizes. Socket heads associated with example embodiments can therefore be used to drive fasteners (including damaged fastening nuts, screws, or bolts with rounded corners) in either direction. Moreover, socket sets according to example embodiments may be more capable of performing successful extractions because the sets include intermediate sizes (including intermediate sizes between adjacent standard sizes of both metric and Society of Automotive Engineers (SAE) socket sizes).

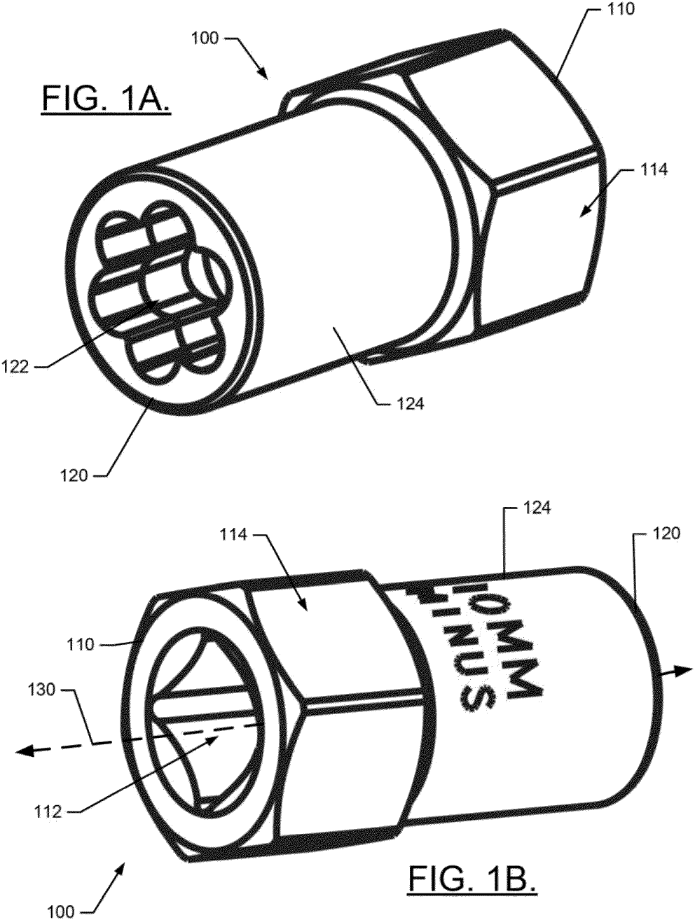

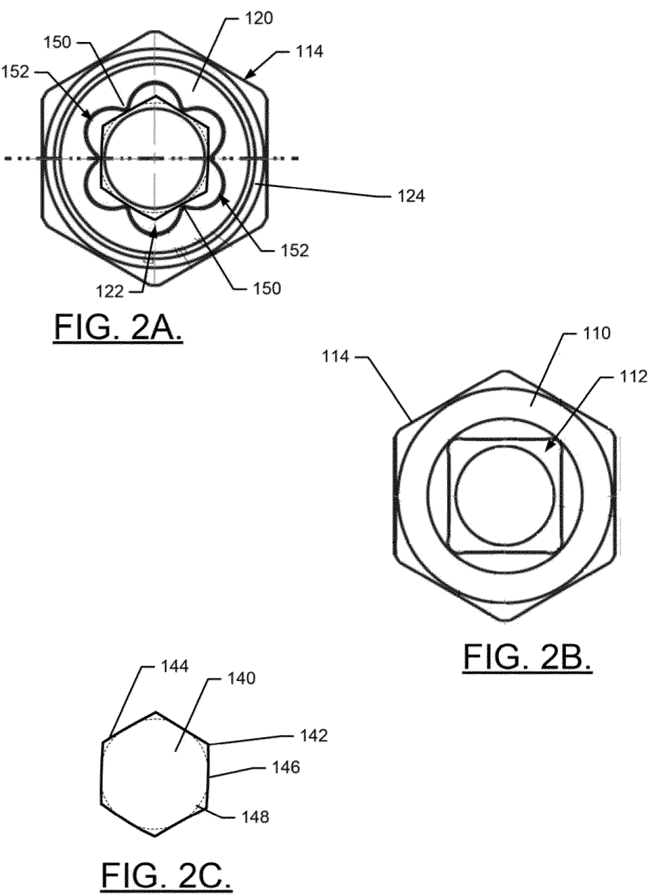

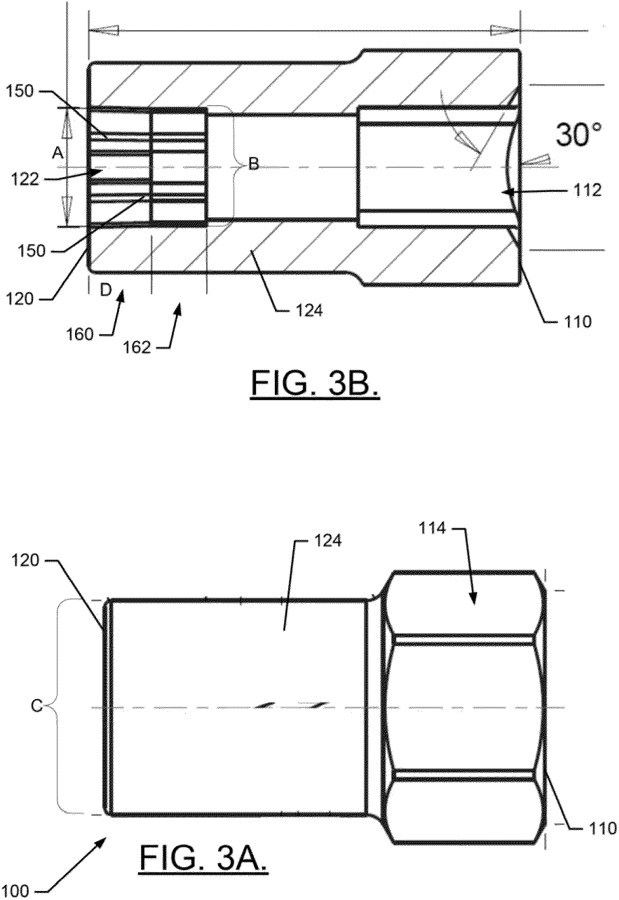

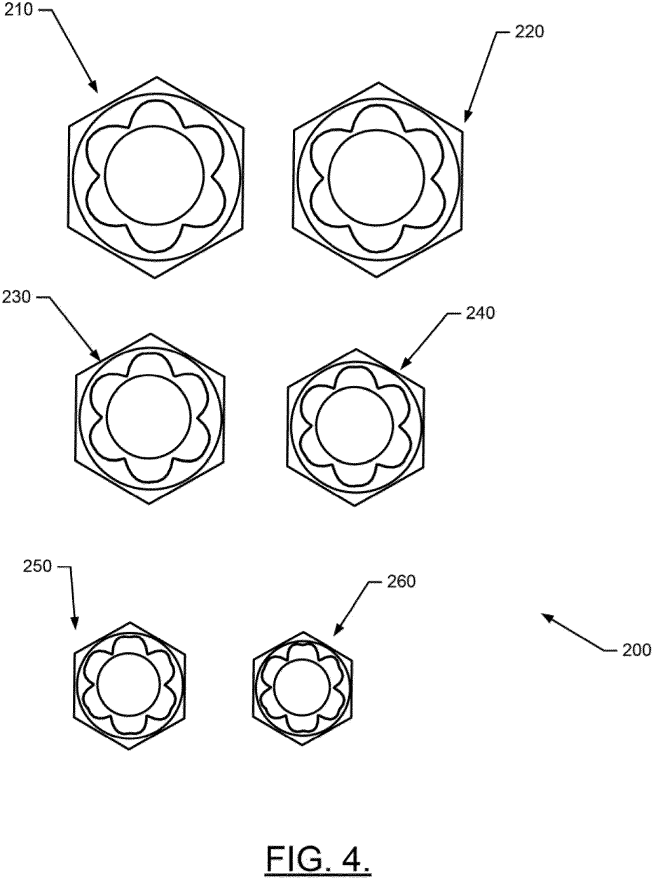

FIG. 1, which is defined by FIGS. 1A and 1B, illustrates perspective views of a bidirectional extractor socket head (i.e., socket head 100) that is configured to drive fasteners (including damaged fasteners) in either direction (i.e., clockwise and counterclockwise or tightening and loosening directions). FIG. 2, which is defined by FIGS. 2A, 2B and 2C, illustrates front and back views of the socket head 100 to illustrate views of a driven end 110 and a drive end 120 of the socket head 100, and illustrates a top view of a hex head fastener (FIG. 2C). FIG. 3, which is defined by FIGS. 3A and 3B, illustrates a side view (FIG. 3A) and a cross section view (FIG. 3B) of the socket head 100 in accordance with an example embodiment.

Referring to FIGS. 1-3, it can be appreciated that the driven end 110 of the socket head includes a drive cavity 112 that may be configured to receive a square drive projection from a socket wrench, impact gun, socket extension, ratchet, and/or the like. The driven end 110 is otherwise formed as a hexagonal end face since a male hex assembly 114 extends away from the driven end 110. The male hex assembly 114 is configured to mate with a female hex assembly of a socket or wrench or an adjustable wrench or pliers. Thus, the driven end 110 may therefore be the end of the socket head 100 at which drive power is received from the wrench, socket, impact gun or other driving tool, by the socket head 100. Moreover, the driven end 110 of this example may be configured to be drivable by any of two different methods of applying the driving force (e.g., internal driving force along the axis (i.e., by the drive projection) or external driving force applied to the periphery of the driven end 110 (i.e., spaced apart from the axis)). As such, driving forces may be applied to the socket head 100 via at least two different driving tools proximate to the driven end 110. Additionally, and as stated above, the driving forces may be applied in either direction, as will be discussed in greater detail below.

The drive end 120 may be the end of the socket head 100 that interfaces with a fastener (e.g., a fastening nut such as a hex nut, a fastening head such as a hex head on a bolt or screw, or other fastener driven by a force applied to the periphery of the fastener nut or fastener head) to drive the fastener responsive to the driving force provided by the driving tool to the driven end 110. The drive end 120 may be shaped substantially as a circular end face that includes a fastener engagement recess 122 that is configured to engage the fastener to allow driving in either of the clockwise or counterclockwise directions. The socket head 100 may include a body portion 124 that extends from the male hex assembly 114 to the drive end 120. The body portion 124 may be a substantially cylindrical body that could have varying desired diameters based on the size of the engagement recess 122 as well as the strength requirements, socket material, manufacturing requirements, and access requirements for the particular application. Typically, the diameter of the body portion 124 will be selected based on a size of fastener that the fastener engagement recess 122 is designed to mate with. In this regard, for example, if the fastener engagement recess 122 is designed to mate with a ½ inch fastener, the diameter of the body portion 124 may be selected to be at least large enough to include the ½ inch sized fastener engagement recess 122 plus sufficient additional support material to allow large amounts of torque to be applied to the fastener via the socket head 100. In some cases, additional size of the diameter may range from 10% to 50%, but other sizes are also possible.

As can be appreciated from FIGS. 1-3, the end faces of the drive end 120 and the driven end 110 each lie in planes that are substantially parallel to each other and spaced apart from each other by the longitudinal length of the socket head 100. Meanwhile, the socket head 100 may have an axis 130 about which the socket head 100 rotates when forces are applied thereto. The axis 130 may form the longitudinal centerline of the socket head 100 and the body portion 124, and may extend substantially perpendicular to the end faces of the driven end 110 and the drive end 120.

Referring specifically to FIG. 2C, an example of the fastener 140 is shown, and may include six corner portions 142 disposed between six side faces 144. The six side faces 144 form a hexagonal shape where each adjacent set of side faces 144 meet at the corner portions 142. The side faces 144 may be substantially straight or flat faces that extend substantially parallel to an axis of the fastener 140. Opposing pairs of the side faces 144 may lie in planes that are parallel to each other. A midpoint 146 of each of the six side faces 144 may be disposed substantially half way between corner portions 142 that are disposed at respective ends of each respective one of the six side faces 144. Over time, or responsive to one or more events that may damage the fastener 140, the corner portions 142 may be stripped or otherwise removed or deformed to form rounded corners 148 shown in FIG. 2C.

The fastener engagement recess 122 may be configured to mate with the fastener 140 in such a way as to create a bidirectional engagement between the midpoint 146 of each of the side faces 144 of the fastener 140 (or a point near the midpoint 146) and the fastener engagement recess 122. In particular, the fastener engagement recess 122 may be defined by engagement ribs 150 that are defined between respective arc shaped grooves 152 or fluted portions. The arc shaped grooves 152 and the engagement ribs 150 may each extend in a direction substantially parallel to the axis 130 to define the depth of the fastener engagement recess 122. A distance between engagement ribs 150 on opposing sides of the fastener engagement recess 122 may define the inside diameter of the fastener engagement recess 122. This distance (i.e., the inside diameter of the fastener engagement recess 122) may be tapered along at least a portion of (and perhaps all of) the length of the engagement ribs 150 such that the engagement ribs 150 are farther apart from each other at the driven end 120 end of the engagement recess 122 than at any other point along the length of the engagement ribs 150. The arc shaped grooves 152 may provide clearance for any corrosion, burring, or other remaining portions of the corner portion 142 that may exist near the rounded corners 148 of a damaged instance of the fastener 140. In some embodiments, the apex of the each engagement rib 150, when viewed from the drive end 120 or a cross-section, substantially forms a corner, which may be a sharp corner that comes to point or may be somewhat rounded having a very small radius of curvature at the apex, such as a radius of substantially 0.5 mm or less.

According to some example embodiments, the engagement ribs 150 may be straight, tapered engagement ribs disposed on the inner surface of the fastener engagement recess 122. The term “straight” may be interpreted to mean that a length of the engagement rib 150 extends in common plane with the axis 130. As such, the engagement ribs may be referred to as being straight because the engagement ribs include an apex that extends linearly for the length of the engagement rib in the same plane as the axis 130. According to some example embodiments, the engagement ribs 150, as further described herein, may also referred to as being tapered because the inner diameter between opposing engagement ribs 150 may decrease along at least a portion of a length of the engagement ribs 150 as the engagement ribs 150 extend from the drive end 120 toward the driven end 110. According to some example embodiments, the straight, tapered engagement ribs 150 result in improved operation of the extractor sockets and inserts that employ such features as described herein. Because the engagement ribs 150 may be straight, the extractor sockets and inserts can engage a fastener to force rotation in either rotational direction (i.e., loosening or tightening) allowancing for extraction of a fastener or re-application of the fastener. Additionally, the straight engagement ribs also allow for the example sockets and inserts to be used as standard sockets, even when a fastener is not damaged.

On fastener 140, the distance between the side faces 144 on opposite sides of each other are normally equal along the entire length of the side faces 144. However, the engagement ribs 150 may be selected to define an initial inner diameter that is larger than the distance between the side faces 144 of the fastener 140 and may taper to an inner diameter that is smaller than the distance between the side faces 144 of the fastener. Thus, the tapered nature of the engagement ribs 150 will cause the engagement ribs 150 to be centered relative to the side faces 144 of the fastener 140 as the fastener 140 is inserted into the fastener engagement recess 122. In particular, after contact is first made between the engagement ribs 150 and the side faces 144, and the engagement ribs 150 slide along the side faces 144 for further insertion of the fastener 140 into the fastener engagement recess 122, the engagement ribs 150 automatically align with the midpoint 146 of the fastener 140 and begin to be tightly engaged therewith. Accordingly, when the fastener 140 is tightly engaged with and inserted into the fastener engagement recess 122, each of the six instances of the engagement ribs 150 will necessarily be in contact with a corresponding one of the midpoints 146 on a standard hex head or nut unless substantially worn or corroded unevenly. Even where substantially and unevenly worn, the fastener will be automatically and substantially centered between at least two opposing ribs that are in contact with a corresponding one of the midpoints 146 (or a point near to the midpoint).

The automatic centering of the engagement ribs 150 not only gives a tight engagement between the engagement ribs 150 and the side faces 144 (i.e., at the midpoint 146), but further creates such engagement in a way that means that turning the socket head 100 in either direction can be accomplished without repositioning the socket head 100. Thus, a reversible ratchet, a wrench or any other driving tool that can be configured to drive in both directions may simply be switched between directions without ever disengaging the socket head 100 so that driving can be accomplished in either direction. This, of course, can provide a huge advantage over a specialized fastener removal socket that is only configured for removal. Given that conventional removal sockets are only configured for removal, the designer’s assumption is generally that the removed fastener will be discarded. Thus, care is not taken to preserve the integrity or condition of the fastener 140 by these specialized removers, and no opportunity for reuse is available to the operator. Operators that would either prefer to reuse the fastener 140, or must do so by necessity, are simply not offered any such option with such conventional removal sockets. Furthermore, the arc shaped grooves 152 of socket head 100 ensure that no further damage is done to the rounded corners 148, and the engagement ribs 150 have engaged the side faces 144 at their strongest point (i.e., midpoint 146) to facilitate no further damage and potential reuse (or at least dual direction driving capability) for the fastener 140 when the socket head 100 of example embodiments is used. In contrast, conventional removal sockets often cause significantly greater damage and deformation to the corners and/or leading edges of the fasteners.

Although the engagement ribs 150 may taper over their entire length in some cases, in other embodiments, the engagement ribs 150 may only taper over a tapered region 160 as shown in FIG. 3B. A fixed distance between the engagement ribs 150 may then be defined in a non-tapered region 162 that is farther from the drive end 120 than the tapered region 160. In some cases, the tapered region 160 may be longer than the non-tapered region 162. However, the length of the engagement ribs 150 (and the arc shaped grooves 152) may in any case be at least as long as the length of the side faces 144 of the fastener 140 that the socket head 100 is configured to engage.

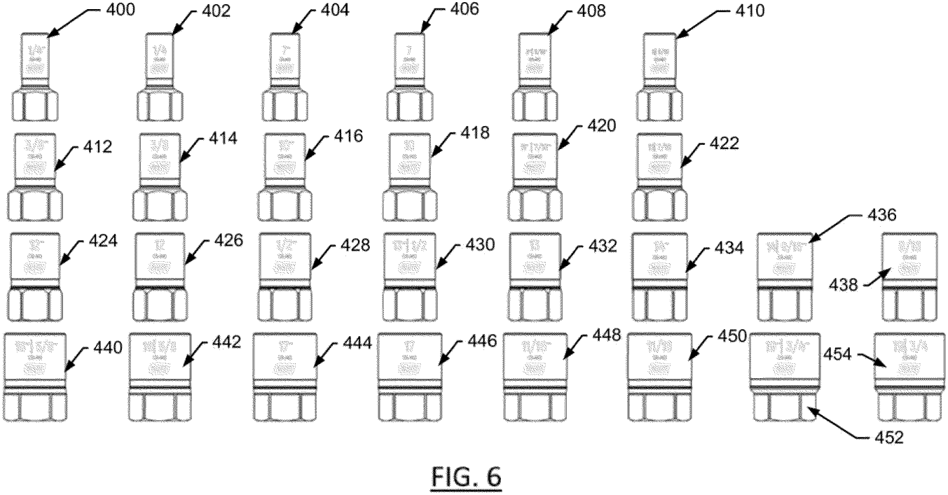

The socket head 100 of an example embodiment can be configured to fit any size of fastener 140. Thus, it may be desirable to provide a plurality of socket heads in a comprehensive set of bidirectional extractor sockets 200 as shown in FIGS. 4 and 6. The set of bidirectional extractor sockets 200 may include a first socket 210 that is configured to fit a standard size (SAE or metric) of fastener. However, rather than immediately providing the next socket in the set at the next standard size, in accordance with an example embodiment, a first intermediate socket 220 (or “minus size” socket) may be provided between the first socket 210 and a second socket 230 that is the next standard size down from the first socket 210. Similarly, a second intermediate socket 240 may be provided between the second socket 230 and the next standard sized socket down (i.e., third socket 250). A third intermediate socket 260 may also be provided for the third socket 250 to be sized between the next standard size down as well.

The first socket 210, the second socket 230, the third socket 250 and any number of additional sockets may each be sized to fit standard sized fasteners. Meanwhile, the first intermediate socket 220, the second intermediate socket 240, the third intermediate socket 260, and any number of additional intermediate sockets, may each be sized in between adj acent standard sizes. Thus, for fasteners that have been worn sufficiently to effectively reduce the length between opposing side faces, the intermediate sockets may be expected to mate securely with such fasteners to maintain the capability to drive the fasteners in both directions as discussed above.

Of note, the set of bidirectional extractor sockets 200 of one example embodiment may include a series of all standard metric sizes, and intermediate sizes between each adjacent one of the standard sizes. Meanwhile, another instance of the set of bidirectional extractor sockets 200 according to another example embodiment may include a series of all standard SAE sizes, and intermediate sizes between each adjacent one of the standard sizes. Still another example set of bidirectional extractor sockets 200 may include a series of all standard metric sizes and all standard SAE sizes, provided in order of decreasing or increasing size intermixing the two standard sizes, along with intermediate sizes between each adjacent one of the standard sizes.

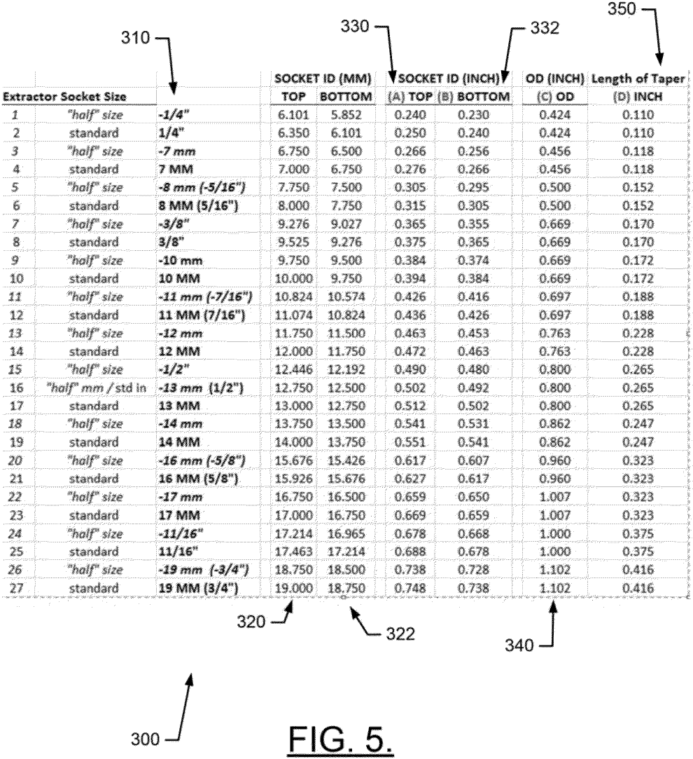

FIG. 5 illustrates a chart 300 of extractor sizes and corresponding characteristics for an example set of bidirectional extractor sockets. In this regard, the chart 300 shows a listing of sizes 310 that includes a plurality of SAE and metric sizes that are considered standard. The listing also includes (between each standard size) a series of intermediate (or “half”) sizes. Column 320 shows the inner diameter at the top (or widest part) of the fastener engagement recess 122 (i.e., proximate to the drive end 120) for each socket size in millimeters, and column 322 shows the inner diameter at the bottom (or narrowest part) of the fastener engagement recess 122 (i.e., at the distal end of the tapered portion 160) in millimeters. Column 330 shows the inner diameter at the top (or widest part) of the fastener engagement recess 122 (i.e., proximate to the drive end 120) for each socket size in inches, and column 332 shows the inner diameter at the bottom (or narrowest part) of the fastener engagement recess 122 (i.e., at the distal end of the tapered portion 160) in inches. Column 340 shows the outer diameter of the body portion 124 of the sockets and column 350 shows the length of taper for each tapered portion 160. Within this context, it should be appreciated that the inner diameter measures the distance between engagement ribs 150 on opposing sides of the fastener engagement recess 122.

As can be appreciated from FIG. 5, each intermediate size socket has a same taper length as one adjacent standard size socket and a different taper length than the other adjacent standard size socket. Meanwhile, each intermediate size socket also extends the inner diameter range of coverage of the one adjacent standard size socket while being discontinuous with the range of coverage of the other adjacent standard size socket. For example, the intermediate size socket between the standard 7 mm socket and the standard ¼ inch socket is the 7 mm “half” size socket. The 7 mm “half” size socket has the same length of taper (i.e., 0.118 inches) as the standard 7 mm socket, and also has a same largest inner diameter (0.266 inches) as the smallest inner diameter of the standard 7 mm socket. The standard 7 mm socket has an inner diameter range that extends from 0.276 inches to 0.266 inches and the 7 mm “half” size socket has an inner diameter range from 0.266 inches to 0.256 inches. Accordingly, the 7 mm “half” size effectively extends the inner diameter range for 7 mm fasteners from 0.276 inches to 0.256 inches to account for smaller (i.e., more worn) fasteners that do not quite fit in the standard ¼ inch socket, which has a length of taper that is 0.110 inches and an inner diameter range that is not coextensive with the 7 mm socket pair (i.e., 0.250 to 0.240 inches).

Thus, according to an example embodiment, a bidirectional extractor socket may be provided. The extractor socket may include a driven end configured to receive drive power from a driving tool, a drive end configured to interface with a fastener, and a body portion extending between the driven end and the drive end about an axis of the extractor socket. The drive end includes a fastener engagement recess extending into the body portion and coaxial with the body portion. The fastener engagement recess is configured to engage with the fastener such that the fastener is drivable in either a clockwise or a counterclockwise direction while avoiding contact with corner portions of the fastener.

In some embodiments, the extractor socket may be configured to include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In an example embodiment, the driven end may include a drive cavity configured to receive a drive projection from a driving tool. In an example embodiment, a male hex assembly may be disposed proximate to the driven end to interface with a driving tool. In an example embodiment, the driven end may include a drive cavity configured to receive a drive projection from a first type of driving tool, and a male hex assembly may be disposed proximate to the driven end to interface with a second type of driving tool. In an example embodiment, the fastener engagement recess may include a plurality of engagement ribs, the engagement ribs extending inwardly toward the axis of the extractor socket and having respective lengths that extend in a direction substantially parallel to the axis of the extractor socket. In an example embodiment, the fastener engagement recess further includes a plurality of arc shaped grooves respective ones of which are formed between the engagement ribs such that the arc shaped grooves also have respective lengths that extend in the direction substantially parallel to the axis of the extractor socket. In an example embodiment, the arc shaped grooves may be configured to align with corner portions of the fastener where the corner portions are disposed between adjacent side faces of the fastener. In an example embodiment, a number of the engagement ribs may be equal to a number of side faces of the fastener. In an example embodiment, the engagement ribs may be disposed in pairs that extend inwardly toward each other to define an inner diameter between opposing ribs of each pair of engagement ribs, and the inner diameter may be largest at the drive end and may decrease along at least a portion of a length of the engagement ribs extending toward the driven end. In an example embodiment, the extractor socket may be configured such that a range in lengths of the inner diameter extends over a standard length between side faces of at least one standard size of fastener. In an example embodiment, the at least one standard size of fastener may be a metric standard size or a Society of Automotive Engineering (SAE) standard size. In an example embodiment, the extractor socket may be configured such that a range in lengths of the inner diameter does not extend over a standard length between side faces of at least one standard size of fastener, but is between two adjacent standard sizes of fastener. In an example embodiment, each of the engagement ribs may be configured to be self-centering relative to a midpoint of a corresponding side face of the fastener responsive to insertion of the fastener into the fastener engagement recess. In an example embodiment, the engagement ribs may have a tapered portion proximate to the drive end and a non-tapered portion extending from the tapered portion toward the driven end.

FIGS. 6-11 illustrate an example embodiment of an extraction set. FIG. 6 illustrates the extractor socket set, which comprises sockets of the following sizes: ¼ inch minus 400, ¼ inch 402, 7 mm minus 404, 7 mm 406, 8 mm minus (which is also 5/16 inch minus) 408, 8 mm (5/16 inch) 410, ⅜ inch minus 412, ⅜ inch 414, 10 mm minus 416, 10 mm 418, 11 mm minus (7/16 inch minus) 420, 11 mm (7/16 inch) 422, 12 mm minus 424, 12 mm 426, ½ inch minus 428, 13 mm minus (½ inch) 430, 13 mm 432, 14 mm minus 434, 14 mm (9/16 inch minus) 436, 9/16 inch 438, 16 mm minus (⅝ inch minus) 440, 16 mm (⅝ inch) 442, 17 mm minus 444, 17 mm 446, 11/16 inch minus 448, 11/16 inch 450, 19 mm minus (¾ inch minus) 452, and 19 mm (¾ inch) 454.

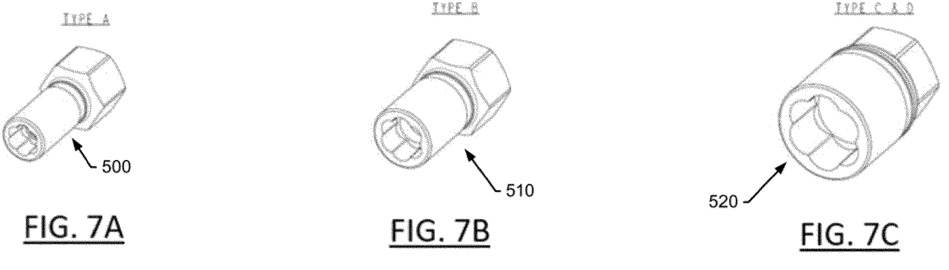

The extraction set of FIG. 6 includes is comprised of four different types of sockets. Within this particular context, the term “type” of socket refers to corresponding different classifications of sockets based on their respective sizes and shapes at the drive and driven ends. FIG. 7A illustrates a perspective view of a first type of an extractor socket 500 according to an example embodiment. This first type is a “neck-down” socket (i.e., the drive end diameter is less than the driven end diameter) with a ¼ inch internal square drive and 16 mm external hex drive.

FIG. 7B illustrates a perspective view of a second type of an extractor socket 510 according to an example embodiment. This second type is a “neck-down” socket with a ⅜ inch internal square drive and 19 mm external hex drive.

FIG. 7C illustrates a perspective view of one example of what could be formed as either a third type or a fourth type of an extractor socket 520 according to an example embodiment depending on the size of the external hex drive with which the extractor socket 520 is configured to interface. This third type is a “neck-up” socket (i.e., the drive end diameter is greater than the driven end diameter or substantially the same) with a ⅜ inch internal square drive and 19 mm external hex drive. This fourth type is a “neck-up” socket with a ⅜ inch internal square drive and 22 mm external hex drive. Therefore, in this example embodiment, the external hex drive of the sockets is not different across all sockets. This way, if a user is driving the extractor socket by the external drive using a wrench, the user will not necessarily always need to use a different sized wrench each time a different extractor socket is selected.

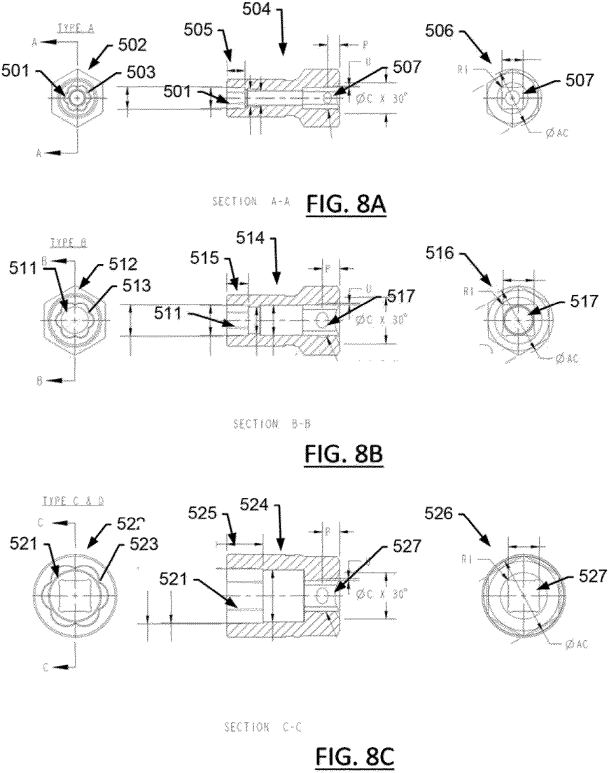

FIG. 8A illustrates a top view 502, side cross section view 504, and bottom view 506 of the first type of extractor socket 500 according to an example embodiment. The top view 502 essentially looks into a fastener engagement recess 501 of the extractor socket 500. Engagement ribs 503 are visible around a periphery of the fastener engagement recess 501. The engagement ribs 503 may extend into the drive end of the extractor socket 500 by a depth 505 that is sufficient to substantially fit a standard sized nut of a given size with which the extractor socket 500 is configured to interface. Meanwhile, the bottom view 506 essentially looks directly into a drive cavity 507 of the extractor socket 500.

FIG. 8B illustrates a top view 512, side cross section view 514, and bottom view 516 of the second type of extractor socket 510 according to an example embodiment. The top view 512 essentially looks into a fastener engagement recess 511 of the extractor socket 510. Engagement ribs 513 are visible around a periphery of the fastener engagement recess 511. The engagement ribs 513 may extend into the drive end of the extractor socket 510 by a depth 515 that is sufficient to substantially fit a standard sized nut of a given size with which the extractor socket 510 is configured to interface. Meanwhile, the bottom view 516 essentially looks directly into a drive cavity 517 of the extractor socket 510.

FIG. 8C illustrates a top view 522, side cross section view 524, and bottom view 526 of the third type of extractor socket 520 according to an example embodiment. The top view 522 essentially looks into a fastener engagement recess 521 of the extractor socket 520. Engagement ribs 523 are visible around a periphery of the fastener engagement recess 521. The engagement ribs 523 may extend into the drive end of the extractor socket 520 by a depth 525 that is sufficient to substantially fit a standard sized nut of a given size with which the extractor socket 520 is configured to interface. Meanwhile, the bottom view 526 essentially looks directly into a drive cavity 527 of the extractor socket 520.

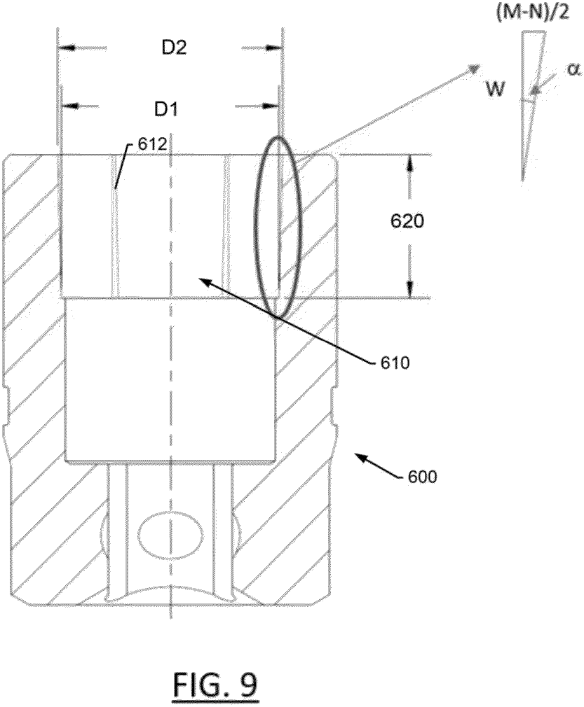

FIG. 9 illustrates a side cross section view of an extractor socket 600 illustrating the tapered fastener engagement recess 610 according to an example embodiment. As noted above, each of the engagement ribs 612 may taper along its longitudinal length so that an inner diameter of the fastener engagement recess 610 decreases as length along the engagement ribs increases. In this regard, a minimum inner diameter (D1) is less than a maximum inner diameter (D2), as shown in FIG. 9. Thus, over a depth 620 of the fastener engagement recess 610, the engagement ribs 612 expand outwardly at an angle of taper (α) relative to a plane parallel to an axis 630 of the extractor socket 600. In some cases, the angle of taper (α) may be less than about 10 degrees. Moreover, in some embodiments, the angle of taper (α) may be less than about 5 degrees. In this regard, for example, the angel of taper (α) may be between 1 and 3 degrees in some cases.

According to some example embodiments, the angle of tapering of the engagement ribs 612 results in improved operation of the example sockets and inserts that employ such ribs having the tapering. The taper angle (e.g., between 1 and 5 degrees) can support engagement of the engagement ribs 612 with the fastener to a degree that does not require, for example, hammering to achieve a sufficient bite on the fastener to subsequently rotate the fastener. IN this regard, engineering studies indicated that a high degree of taper (e.g., ten degrees or more) leads to a small degree of engagement and insufficient bite to apply the torque needed to sufficiently loosen or tighten a fastener without slippage, and the requirement of hammering the socket onto the fastener to overcome such slippage. Alternatively, a very small taper (e.g., less than one degree) does not permit the target sized fastener to effectively seat within the fastener engagement recess 122 and also have sufficient bite into the fastener to support the applied torque needed to tighten or untighten the fastener. In light of these considerations, the amount of taper (for example, between one to five degrees) was determined as being superior based in part on trial-and-error testing of different taper angles. As such, according to some example embodiments, a taper angle of between one and five degrees allows the extractor socket or insert to easily slide, with little to no force, onto the fastener and sufficiently bites the fastener to facilitate untightening or tightening of a damaged fastener, without further damage to the fastener. As such, practices such as hammering the socket or insert to engage with the fastener, or for removal of the fastener from the socket or insert is required. According to some example embodiments, due to the selected taper angle of between 1 and 5 degrees, the fastener has simply fall from the fastener engagement recess 122 after extraction with little or no effort from the user. Because hammering is not necessary, damage to the socket or insert is also avoided leading to longer life and longevity of the socket or insert. As such, according to some example embodiments, the use of a taper angle of one to five degrees supports an increased bite or gripping ability and improved longevity.

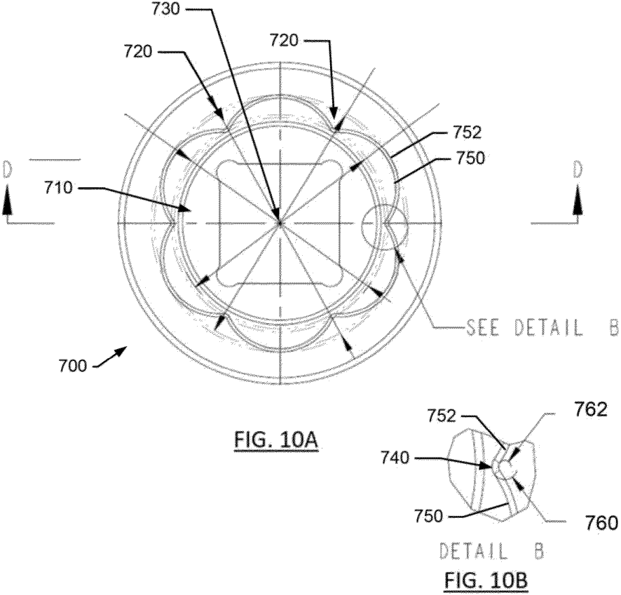

FIG. 10A illustrates a top view of an extractor socket 700 illustrating the changes in diameter of the tapered fastener engagement recess 710 according to an example embodiment. In this regard, the engagement ribs 720 each extend inwardly toward an axis 730 of the extractor socket 700. As such, a periphery of the fastener engagement recess 710 is formed by alternating portions of smaller diameter (i.e., where the engagement ribs 720 are formed) and larger diameter (i.e., between the engagement ribs 720). The engagement ribs 720 are formed by surfaces that slant inwardly toward the axis 730 on opposite sides of an apex 740 that defines the minimum diameter for the fastener engagement recess 710 at any corresponding depth of the fastener engagement recess 710. As noted above, the engagement ribs 720 also slant toward the axis 730 as depth into the fastener engagement recess 710 increases. As a result, a first periphery 750 of the fastener engagement recess 710, at a deepest depth of the fastener engagement recess 710, has a smaller diameter at all points along its surface than a second periphery 752, at a shallowest depth of the fastener engagement recess 710. Although the apex 740 could be formed to define a point, some embodiments may instead form the apex 740 to be slightly rounded instead.

FIG. 10B illustrates a close up view of the apex 740 of one of the engagement ribs 720 according to an example embodiment. In particular, the apex 740 of FIG. 10B is shown to demonstrate that the apex 740 is not a sharp point, but has a small area of curvature. Moreover, in some example embodiments, the degree of curvature of the apex 740 may be formed such that the curvature gets slightly larger as depth into the tapered fastener engagement recess 710 increases. Given the change in diameter between the first periphery 750 and the second periphery 752, it can be appreciated that a first radius 760 defining the curvature of the apex 740 at the first periphery 750 is larger than a second radius 762 defining the curvature of the apex 740 at the second periphery 752, as shown in FIG. 10B.

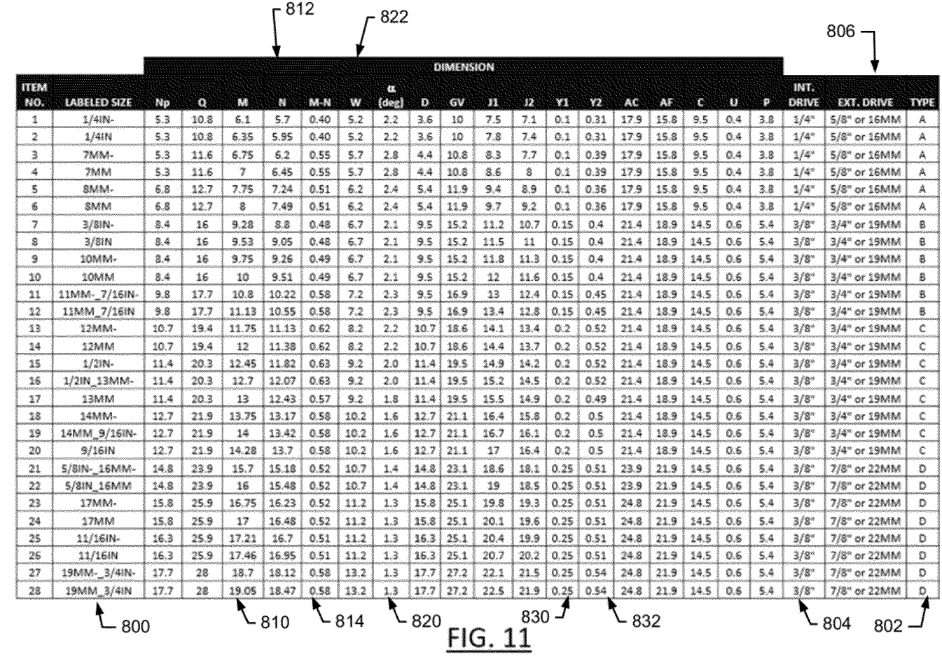

FIG. 11 illustrates a chart of size characteristics of various extractor sockets in a set of extractor sockets depicted in FIG. 6-10B according to an example embodiment. As shown in FIG. 11, a size column 800 defines each respective size of extractor socket. Type column 802 defines respective different socket types which, as noted above, are defined based on their internal and external drive characteristics. Internal drive column 804 shows internal drive characteristics and external drive column 806 shows external drive characteristics. Column 810 illustrates a largest fastener engagement recess diameter (in mm) for each socket, and column 812 illustrates a smallest fastener engagement recess diameter for each socket. Column 814 illustrates a difference therebetween. Column 820 illustrates angle of taper (α) and column 822 illustrates the depth of the fastener engagement recess for each socket. Column 830 illustrates the radius at the apex at a shallow end of the fastener engagement recess, and column 832 illustrates the radius at the apex at the deep end of the fastener engagement recess. It should be appreciated that the sizes and dimensions have been created after extensive research and experimentation to balance various, and often competing, performance characteristics such as strength, durability, size, access, cost, and convenience to the end user.

Lab results testing performance and life cycles for extractor sockets of example embodiments have demonstrated that extractor sockets formed as described herein have up to ten times longer impact life than conventional extractors. In particular, conventional extractors tested alongside a 5/16 inch extractor socket of an example embodiment experienced failures of hex mandrel corner rounding and socket bit edge deformation in less than 300 cycles. However, the extractor socket of an example embodiment did not receive any such failure after at least 500 cycles with an impact torque applied of 40 ft-lb. Example embodiments also experience up to five times greater torque output relative to conventional extractors. In this regard, testing showed that a peak torque of over 500 inch-pounds was achieved by example embodiments before corner rounding occurred, whereas all conventional extractors experienced failure at less than about 155 inch-pounds for a 5/16 inch extractor overload test on 75% rounded hex nuts. ½ inch overload tests on 75% rounded hex nuts demonstrated failure for example embodiments at about 1579 inch-pounds of peak torque, whereas all conventional extractors failed by less than about 265 inch-pounds of peak torque. Meanwhile, for a ¾ inch overload test on 75% rounded hex nuts, example embodiments did not fail at all by 5500 inch-pounds of peak torque (at which point testing was suspended), whereas each conventional extractor had failed by less than about 320 inch-pounds of peak torque. Testing for removal of a fastener followed by reuse of the same fastener also illustrated superior results. In this regard, for example, the fastener engagement recess of example embodiments proved to be configured to engage with the fastener for removal of the fastener and subsequently engage with the same fastener to reuse the fastener and achieve both a peak removal torque and a peak installation torque of greater than about 500 inch-pounds. No conventional extractor tested was able to achieve such results. Thus, not only can example embodiments outperform the competition in robustness and longevity, but the bi-directional nature of example embodiments may further allow the same damaged, weathered, rusted and/or corroded fastener to not only be removed, but to be reused if no suitable alternative is available.

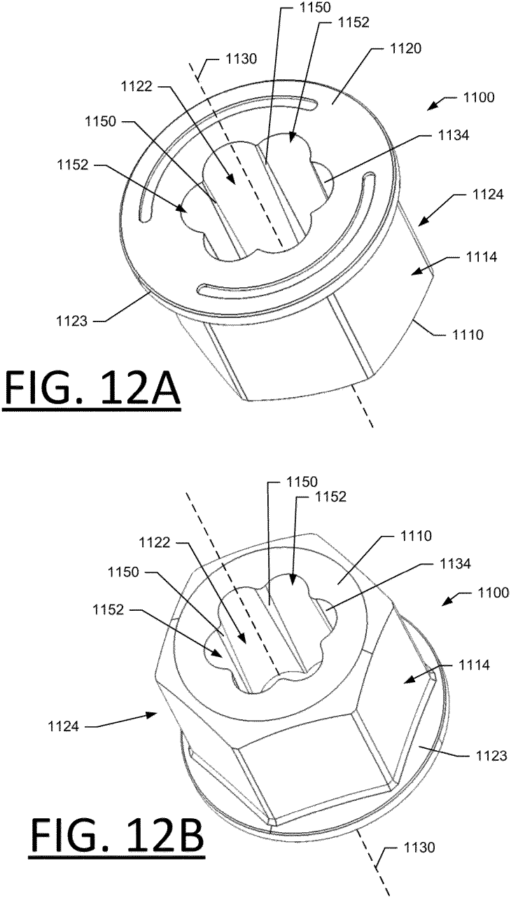

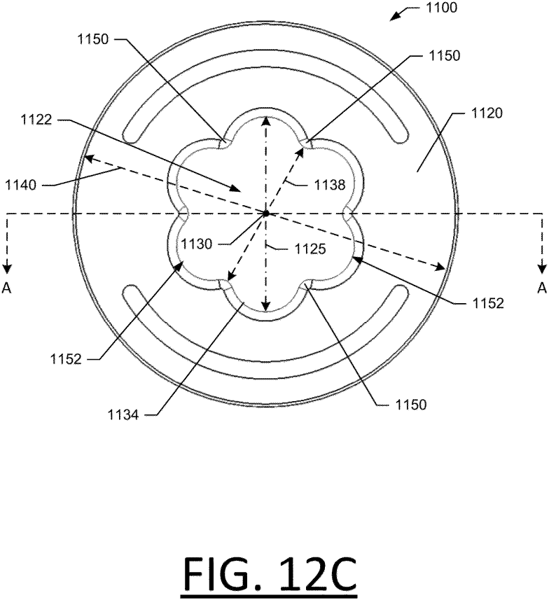

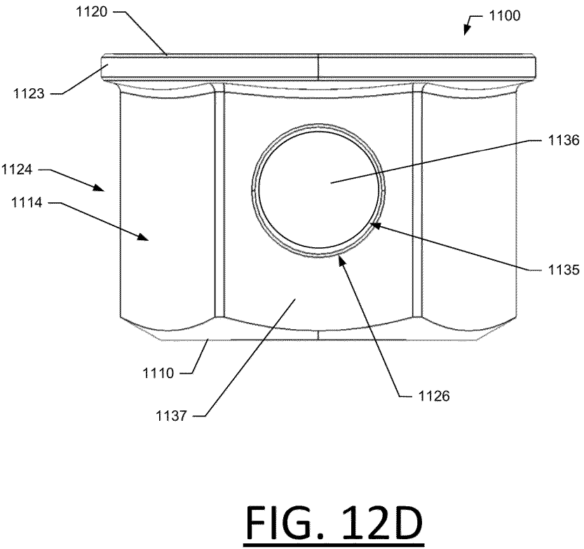

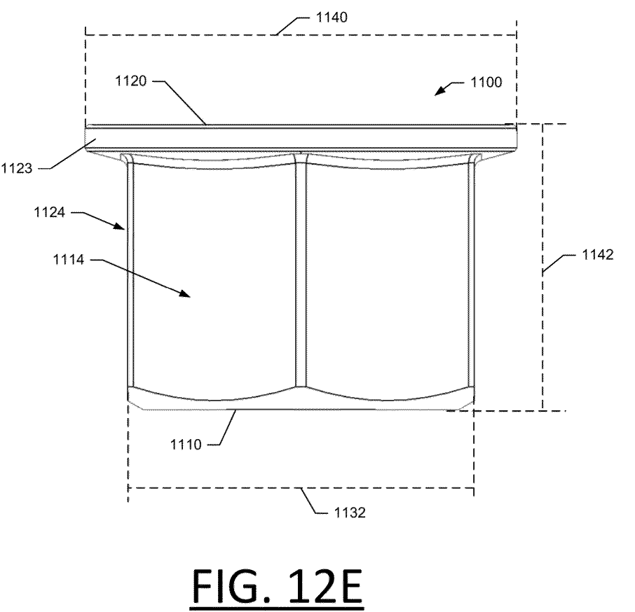

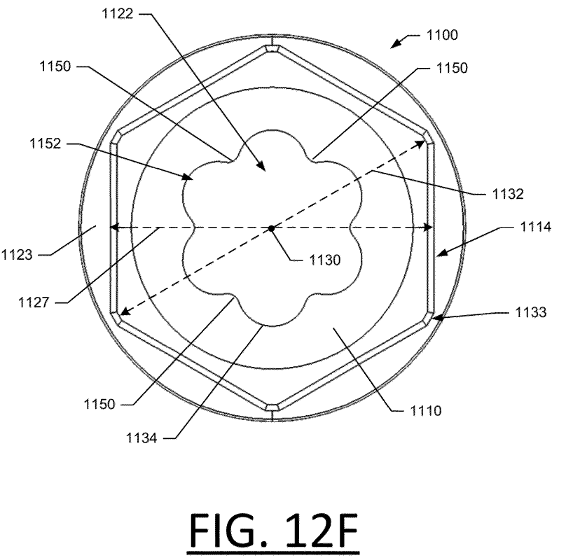

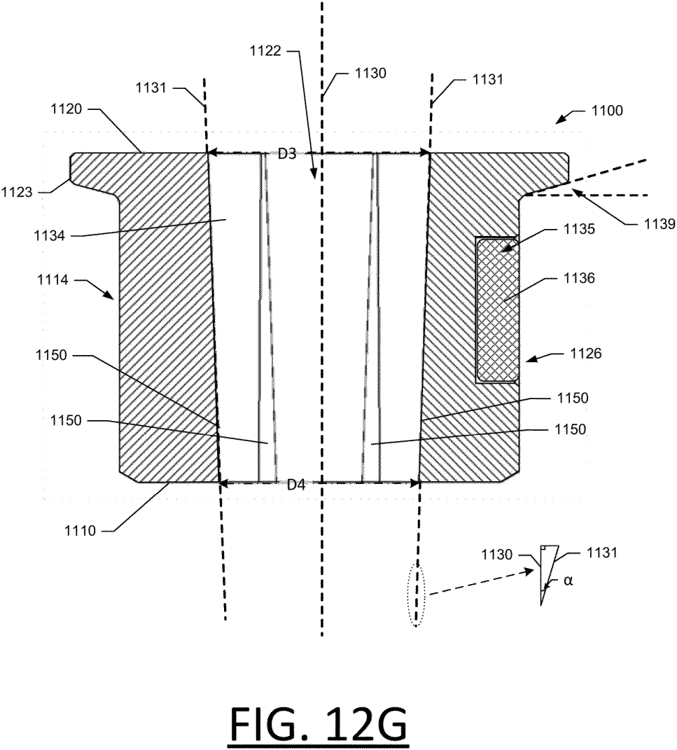

Having described some example embodiments in the form of extractor sockets, FIGS. 12A to 14B will now be described that which are directed to some example embodiments in the form of extractor inserts. An insert, as further described herein, may be a device that is configured to engage with a driving tool, such as a box wrench, at a driven end and a fastener at a drive end. According to some example embodiments, an insert may be differentiated from a socket in that the insert may not include a drive cavity that would interface with, for example, a drive tang of a socket wrench. An insert may include an external surface assembly, similar to, for example, the male hex assembly 114, that is configured to interface with a wrench or other driving tool. According to some example embodiments, an entire exterior of a body of an insert may be an external surface assembly for interfacing with a wrench or other driving tool.

An insert, according to some example embodiments, may include a fastener engagement recess that is the same or similar to the fastener engagement recesses 122, 501, 511, 521, 610, or 710 described with respect to the example extractor socket embodiments of FIG. 1A to FIG. 11. According to some example embodiments, unlike some of the socket example embodiments, the characteristics of the fastener engagement recesses, i.e., the engagement ribs and arc shaped grooves, of an extractor insert may extend across an entire length of a through channel of the insert. Additionally, according to some example embodiments, an insert may include a securing lip that may rest against a surface of the driving tool to maintain the insert in an engaged position within a drive opening of a driving tool, e.g., a wrench or hand driver. Also, according to some example embodiments, an insert may include a securing feature in the form of a magnet that applies a magnetic bias between the insert and the driving tool to maintain the insert within the drive opening the driving tool.

Accordingly, some example embodiments may relate to the provision of an extractor insert that may be bidirectional, and an associated insert set including a plurality of such bidirectional extractor inserts that include intermediate or minus sizes. Inserts associated with example embodiments can therefore be used to drive fasteners (including damaged fastening nuts, screws, or bolts with rounded corners) in either direction. Moreover, insert sets according to example embodiments may be more capable of performing successful extractions because the sets include intermediate sizes (including intermediate sizes between adjacent standard sizes of both metric and Society of Automotive Engineers (SAE) sizes).

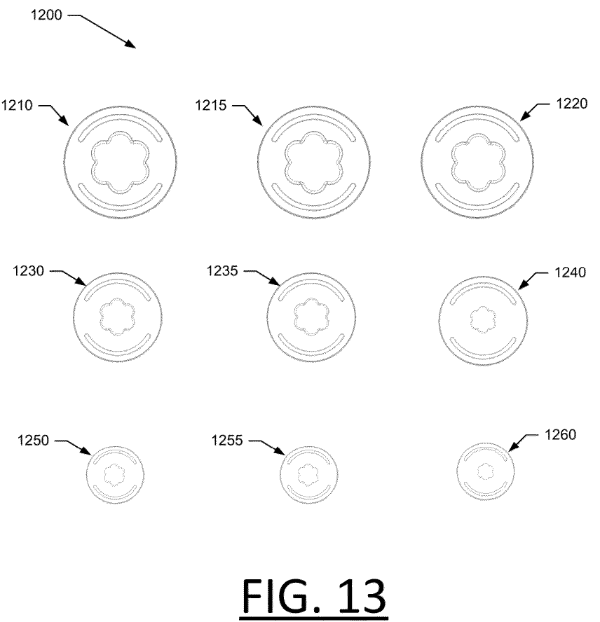

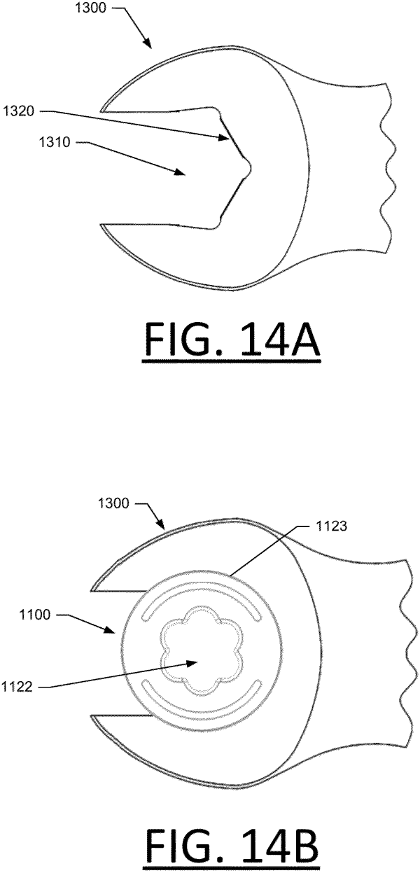

FIGS. 12A to 12F illustrate different external views of an example extractor insert 1100 that is configured to drive fasteners (including damaged fasteners) in either direction (i.e., clockwise and counterclockwise or tightening and loosening directions). FIG. 12A is a perspective top or drive end view of the extractor insert 1100, and FIG. 12B is a perspective bottom or driven end view of the extractor insert 1100. FIG. 12C shows a drive end view of the extractor insert 1100. FIG. 12D is a first side view of the extractor insert 1100 showing the magnet assembly 1126, according to some example embodiments. FIG. 12E shows a second side view of the extractor insert 1100. FIG. 12F shows a driven end view of the extractor insert 1100. FIG. 12G illustrates a cross-section view of the extractor insert 1100 taken at A-A of FIG. 12C. Additionally, FIG. 13 illustrates an example set of extractor inserts 1200. FIG. 14A illustrates an example driving tool in the form of a wrench head 1300 and FIG. 14B illustrates the extractor insert 1100 engaged in a drive opening 1310 of the wrench head 1300.

A body 1124 of an example extractor insert 1110 at or adjacent a driven end 1110 may include a drive surface assembly 1114. The drive surface assembly 1114 may formed by external engaging surfaces of the body 1124 that are configured to engage with a complementary driving tool. In this regard, the drive surface assembly 1114 may be configured to engage with a drive opening of a driving tool to permit a rotational force to be applied to the extractor insert 1100. According to some example embodiments, the drive opening of the driving tool may have a standard distance between opposing drive surfaces, and the therefore the opposing engaging surfaces of the drive surface assembly 1114 may be positioned a distance 1127 that is, for example, the same or slightly less than the standard distance between the drive surfaces of the driving tool to allow for efficient engagement. As such, the distance between the external engaging surfaces of the drive surface assembly 1114 is shown in FIG. 12F as distance 1127. The driven end 1110 of the body 1124 and the extractor insert 1110 may be formed as a hexagonal end face in an instance in which the drive surface assembly 1114 extends away from the driven end 1110 as a male hex assembly. As such, the maximum distance across the drive surface assembly 1114 (e.g., between opposing meeting edges of the external engaging surfaces of the drive surface assembly 1114 measured through the central axis 1130) is shown as a distance 1132, which may be referred to as the drive surface assembly diameter 1132 or body width 1132. According to some example embodiments, as an extractor insert, the drive surface assembly diameter 1132 may be larger than a height 1142 of the extractor insert 1100 to limit a depth that the extractor insert 1100 extends into the drive opening of the drive tool.

According to some example embodiments, the edges where the external engaging surfaces meet each adj acent external engaging surface may be chamfered or rounded as best shown in FIG. 12F at edge 1133. The drive surface assembly 1114 may be configured to mate with a female hex assembly of, for example, a fixed head wrench, an adjustable wrench, pliers, a hand driver, a ratcheting box wrench, or the like. Thus, the driven end 1110 may therefore be the end of the extractor insert 1100 at which drive power is received from the driving tool, by the extractor insert 1100. Moreover, the driven end 1110 of this example may be configured to be drivable by applying an external driving force to the periphery of the driven end 1110 or more specifically, the drive surface assembly 1114. Additionally, and as stated above, the driving forces may be applied in either direction.

The drive end 1120 may be the end of the extractor insert 1100 that interfaces with a fastener (e.g., a fastening nut such as a hex nut, a fastening head such as a hex head on a bolt or screw, or other fastener driven by a force applied to the periphery of the fastener nut or fastener head) to drive the fastener responsive to the driving force provided by the driving tool to the driven end 1110. The drive end 1120 may be shaped substantially as a circular end face that includes a fastener engagement recess 1122 that is configured to engage the fastener to allow driving in either of the clockwise or counterclockwise directions. A securing lip 1123 may be disposed at the drive end 1120 and may extend radially from the drive end 1120 of the body 1124.

The body 1124 may be an elongate portion of the extractor insert 1100 that includes the centrally located fastener engagement recess 1122 that could have certain strength requirements, insert material, manufacturing requirements, and access requirements for the particular application. The body 1124 may extend from the drive end 1120 to a driven end 1110 along the central axis 1130 and may comprise the fastener engagement recess 1122 and the drive surface assembly 1114. The fastener engagement recess 1122 may be defined by internal sidewalls 1134 of an internal through channel in the body 1124 extending along the central axis 1130. According to some example embodiments, various features of the fastener engagement recess 1122 may be defined by structural features of the internal sidewalls 1134 including, for example, engagement ribs 1150 and arc shaped grooves 1152. According to some example embodiments, the fastener engagement recess 1122 may extend as a channel through the body 1124 with openings on both the drive end 1120 and the driven end 1110. Typically, a width of the body 1124 may be selected based on a size of fastener that the fastener engagement recess 1122 is designed to mate with. In this regard, for example, if the fastener engagement recess 1122 is designed to mate with a ½ inch fastener, the width of the body 1124 may be selected to be at least large enough to include the ½ inch sized fastener engagement recess 1122 plus sufficient additional support material to allow large amounts of torque to be applied to the fastener via the extractor insert 1100. In some cases, additional size of the width may range from 10% to 50% of the size of the fastener, but other sizes are also possible.

As can be appreciated from FIGS. 12A, 12B, 12D, and 12G, the end faces of the drive end 1120 and the driven end 1110 each lie in planes that are substantially parallel to each other and spaced apart from each other by the longitudinal length of the extractor insert 1100. Meanwhile, the extractor insert 1100 may have an axis 1130 about which the extractor insert 1100 rotates when forces are applied thereto. The axis 1130 may form the longitudinal centerline of the extractor insert 1100 and the body 1124, and may extend substantially perpendicular to the end faces of the driven end 1110 and the drive end 1120.

As mentioned above, the extractor insert 1100 may include a securing lip 1123. The securing lip 1123 may being configured to cause the drive end 1120 to extend out radially from axis 1130 than the body 1124 and the drive surface assembly 1114. With reference to FIG. 12C, the securing lip 1123 may define a securing lip diameter or width 1140 across the drive end 1120 of the extractor insert 1100 and through the central axis 1130. As such, the securing lip 1123 may function to prevent the extractor insert 1100 from passing through a drive opening in a driving tool (e.g., that is sized for the drive surface assembly 1114) or passing to far into a cavity of a drive opening. As such, the securing lip 1123 may rest on an edge of the drive opening of a driving tool while the drive surface assembly 1114 is laterally engaged with driving surfaces of the driving tool. The securing lip 1123 therefore provides for “drop in” coupling of the extractor insert 1100 with the drive opening of a driving tool. In this regard, the securing lip 1123 may define a securing lip diameter or width 1140 through the central axis 1130 and the body 1124 may defines a body width 1132 through the central axis 1130. According to some example embodiments, due to, for example, the securing lip width 1140 may be larger than the body width 1132 to thereby form the securing lip 1123 as a catch that engages with an edge of a drive opening in a driving tool.

According to some example embodiments, a top side at the drive end 1120 of the securing lip 1123 may be flat or planar (e.g., extending perpendicular to the central axis 1130) and an underside of the securing lip 1123 (i.e., opposite the top side) may be angled at a lip angle 1139 from an outer surface of the securing lip 1123 to an interface of the securing lip 1123 with the body 1124. The lip angle 1139 may be greater than 5 degrees and may preferably be about 15 degrees. The lip angle 1139 may, according to some example embodiments, operate as a key feature with an edge of a drive opening of a drive tool that has a corresponding angled surface to closely engage with the underside of the securing lip 1123.

According to some example embodiments, the extractor insert 1100 may include other securing features for maintain the extractor insert 1100 within a drive opening of a driving tool. For example, as shown in FIGS. 12D and 12G, the extractor insert 1100 may include a magnet assembly 1126 comprising a magnet 1136 that creates a magnetic bias between the extractor insert 1100 and the driving surfaces of the driving tool. According to some example embodiments, the magnet 1136 may be disposed on one or more of the surfaces of the drive surface assembly 1114 that interface with the drive surfaces of the driving tool. In the example embodiment shown in FIG. 12D, the magnet 1136 is disposed on one surface of the drive surface assembly 1114. In this regard, the surface 1137 may include a magnet recess 1135 within which the magnet 1136 is disposed. The magnet 1136 may be secured in the recess 1135 by, for example, an adhesive, by the magnetic force of the magnet 1136 itself, or the like. According to some example embodiments, the magnet 1136 may be sealed into the recess 1135. According to some example embodiments, the magnet assembly 1126 may include a cover, in the shape of, for example, a cup that is secure over the exterior of the magnet 1136. According to some example embodiments, since the magnet 1136 may be brittle relative to the material of the body 1124, the external surface of the magnet 1136 may be recessed relative to the surface 1137 to prevent forces from the driving tool from being directly applied to the magnet 1136. Further, according to some example embodiments, a depth of the magnet recess 1135 may be less than half of a thickness of the body 1124 between the internal sidewall adjacent to the magnet recess 1135 and the external engaging surface within which the magnet recess 1135 is formed to ensure sufficient torque strength of the body 1124 at the magnet recess 1135.

The fastener engagement recess 1122 may be configured to mate with the fastener 140 (FIG. 2C) in such a way as to create a bidirectional engagement between the midpoint 146 of each of the side faces 144 of the fastener 140 (or a point near the midpoint 146) and the fastener engagement recess 1122. In particular, the fastener engagement recess 1122 may be defined by engagement ribs 1150 that are defined between respective arc shaped grooves 1152 or fluted portions. A plurality of engagement ribs 1150 may extend from the internal sidewalls 1134 of the body 1124 towards the central axis 1130. Each engagement rib 1150 may comprising an apex that extends along a length of the engagement rib 1150. Further, each engagement rib 1150 may have an opposing engagement rib 1150 such that apexes of opposing engagement ribs are disposed on a common plane with the central axis 1130.

Arc shaped grooves 1152 and the engagement ribs 1150 may each extend in a direction substantially parallel to the axis 1130 to define the depth of the fastener engagement recess 1122. An arc shaped groove 1152 may transition into an engagement rib 1150 comes to a peak or apex, that, according to some example embodiments, is not a sharp point, but has a small area of curvature. According to some example embodiments, the depth of the fastener engagement recess 1122 may be same as the height of the extractor insert 1100. In other words, the fastener engagement recess 1122 may extend from the drive end 1120 to the driven end 1110. A distance between engagement ribs 1150 on opposing sides of the fastener engagement recess 1122 (i.e., rib apex to rib apex) may define the inside diameter 1138 of the fastener engagement recess 1122. A distance between the minimums or deepest points of opposing arc shaped groove 1152 may define the inside groove diameter 1125 of the fastener engagement recess 1122. The inside diameter 1138 of the fastener engagement recess 1122 may be tapered along at least a portion of (and perhaps all of) the length of the engagement ribs 1150 such that the engagement ribs 1150 are farther apart from each other at the driven end 1120 end of the engagement recess 1122 than at any other point along the length of the engagement ribs 1150. In this regard, according to some example embodiments, each apex of an engagement rib 1150 may taper at a taper angle relative to the central axis 1130 such that a distance between apexes of opposing engagement ribs 1150 is largest at the drive end 1120 and smallest at the driven end 1110.

The arc shaped grooves 1152 may provide clearance for any corrosion, burring, or other remaining portions of the corner portion 142 that may exist near the rounded corners 148 of a damaged instance of the fastener 140. In some embodiments, the apex of the each engagement rib 1150, when viewed from the drive end 1120 or a cross-section, substantially forms a corner, which may be a sharp corner that comes to point or may be somewhat rounded having a very small radius of curvature at the apex, such as a radius of substantially 0.5 mm or less. According to some example embodiments, apexes of opposing engagement ribs 1150 and the axis 1130 of the extractor insert 1100 may be disposed in a common plane.

Of course, on fastener 140 the distance between the side faces 144 on opposite sides of each other are normally equal along the entire length of the side faces 144. However, the engagement ribs 1150 may be selected to define an initial inside diameter that is larger than the distance between the side faces 144 of the fastener 140 and may taper to an inside diameter that is smaller than the distance between the side faces 144 of the fastener. Thus, the tapered nature of the engagement ribs 1150 will cause the engagement ribs 1150 to be centered relative to the side faces 144 of the fastener 140 as the fastener 140 is inserted into the fastener engagement recess 1122. In particular, after contact is first made between the engagement ribs 1150 and the side faces 144, and the engagement ribs 1150 may slide along the side faces 144 for further insertion of the fastener 140 into the fastener engagement recess 1122, the engagement ribs 1150 automatically align with the midpoint 146 of the fastener 140 and begin to be tightly engaged therewith. Accordingly, when the fastener 140 is tightly engaged with and inserted into the fastener engagement recess 1122, each of the six instances of the engagement ribs 1150 will necessarily be in contact with a corresponding one of the midpoints 146 on a standard hex head or nut unless substantially worn or corroded unevenly. Even where substantially and unevenly worn, the fastener 140 will be automatically and substantially centered between at least two opposing ribs that are in contact with a corresponding one of the midpoints 146 (or a point near to the midpoint).

The automatic centering of the engagement ribs 1150 not only gives a tight engagement between the engagement ribs 1150 and the side faces 144 (i.e., at the midpoint 146), but further creates such engagement in a way that means that turning the extractor insert 1100 in either direction can be accomplished without repositioning the extractor insert 1100. Thus, a reversible ratchet, a wrench or any other driving tool that can be configured to drive in both directions may simply be switched between directions without ever disengaging the extractor insert 1100 so that driving can be accomplished in either rotational direction. This, of course, can provide a huge advantage over a specialized fastener removal sockets and inserts that are only configured for removal. Given that conventional removal sockets and inserts are only configured for removal, the designer’s assumption is generally that the removed fastener will be discarded. Thus, care is not taken to preserve the integrity or condition of the fastener 140 by these specialized removers, and no opportunity for reuse is available to the operator. Operators that would either prefer to reuse the fastener 140, or must do so by necessity, are simply not offered any such option with such conventional removal sockets. Furthermore, the arc shaped grooves 1152 of extractor insert 1100 ensure that no further damage is done to the rounded corners 148, and the engagement ribs 1150 have engaged the side faces 144 at their strongest point (i.e., midpoint 146) to facilitate no further damage and potential reuse (or at least dual direction driving capability) for the fastener 140 when the extractor insert 1100 of example embodiments is used. In contrast, conventional removal sockets often cause significantly greater damage and deformation to the corners and/or leading edges of the fasteners. It is often the situation that a replacement fastener is not readily available for re-assembly of the work piece. Unfortunately, since the fastener is also further damaged or destroyed by the hammering involved in the extraction process with many conventional extractor sockets and inserts, the fastener often cannot be reused. Such an outcome is particularly problematic when the fastener is a non-standard part that may require ordering and delivery to replace - if replacement parts are available at all. It is particularly common for specialized fasteners that are difficult to replace to be used, for example, in the automotive industry resulting in an individual’s means of transportation being unavailable due to the ordering of a component as simple as a bolt. According to some example embodiments, this technical problem is overcome by the non-destructive removal and re-application of the previously damaged fastener by example sockets and inserts described herein.

Although the engagement ribs 1150 may taper over their entire length in some cases, in other embodiments, the engagement ribs 1150 may only taper over a tapered region. A fixed distance between the engagement ribs 1150 may then be defined in a non-tapered region that is farther from the drive end 1120 than the tapered region. In some cases, the tapered region may be longer than the non-tapered region. However, the length of the engagement ribs 1150 (and the arc shaped grooves 1152) may in any case be at least as long as the length of the side faces 144 of the fastener 140 that the extractor insert 1100 is configured to engage.

FIG. 12G illustrates a side cross section view of the extractor insert 1100 illustrating the tapered fastener engagement recess 1122 according to an example embodiment. As noted above, each of the engagement ribs 1150 may taper along its longitudinal length (as indicated by lines 1130) so that an inside diameter of the fastener engagement recess 1122 decreases as length along the engagement ribs increases from the drive end 1120 to the driven end 1110. In this regard, a minimum inner diameter (D4) is less than a maximum inner diameter (D3), as shown in FIG. 12G. Thus, over a depth of the fastener engagement recess 1122, the engagement ribs 1150 expand outwardly at an angle of taper (α) relative to a plane parallel to the axis 1130 or a plane parallel to the axis 1130 of the extractor insert 1100. In some cases, the angle of taper (α) may be less than about 10 degrees. Moreover, in some embodiments, the angle of taper (α) may be less than about 5 degrees, and may be between 1 and 5 degrees. In this regard, for example, the angel of taper (α) may be between 1 and 3 degrees in some cases. FIG. 11, described above, illustrates a chart of size characteristics of various extractor sockets in a set of extractor sockets depicted in FIG. 6-10B according to an example embodiment. However, the same internal dimensions of a fastener engagement recess as indicated in FIG. 11 may be applicable to a set of extractor inserts.

The extractor insert 1100 of an example embodiment can be configured to fit any size of fastener 140. Thus, it may be desirable to provide a plurality of extractor inserts 1100 in a comprehensive set of bidirectional extractor sockets 1200 as shown in FIG. 13. The set of bidirectional extractor inserts 1200 may include a first insert 1210 that is configured to fit a standard size (SAE or metric) of fastener. However, rather than immediately providing the next insert in the set at the next standard size, in accordance with an example embodiment, a first intermediate 1215 (or “minus size” insert) may be provided between the first insert 1210 and a third insert 1220 that is the next standard size down from the first insert 1210. Similarly, a second intermediate socket 1235 may be provided between the fourth insert 1230 and the next standard sized socket down (i.e., fifth insert 1240). A third intermediate socket 1255 may also be provided be sized between the sixth insert 1250 and the seventh insert 1260 that are the next standard sizes down.

For example, the first insert 1210, the second insert 1220, the third insert 1230, the fourth insert 1240, the fifth insert 1250, the sixth insert 1260, and any number of additional sockets may each be sized to fit standard sized fasteners. Meanwhile, the first intermediate insert 1215, the second intermediate insert 1235, the third intermediate insert 1255, and any number of additional intermediate sockets, may each be sized in between adjacent standard sizes. Thus, for fasteners that have been worn sufficiently to effectively reduce the length between opposing side faces, the intermediate sockets may be expected to mate securely with such fasteners to maintain the capability to drive the fasteners in both directions as discussed above.

Of note, the set of bidirectional extractor inserts 1200 of one example embodiment may include a series of all standard metric sizes, and intermediate sizes between each adjacent one of the standard sizes. Meanwhile, another instance of the set of bidirectional extractor inserts 1200 according to another example embodiment may include a series of all standard SAE sizes, and intermediate sizes between each adjacent one of the standard sizes. Still another example set of bidirectional extractor insert 1200 may include a series of all standard metric sizes and all standard SAE sizes, provided in order of decreasing or increasing size intermixing the two standard sizes, along with intermediate sizes between each adjacent one of the standard sizes. According to some example embodiments, a set of inserts may be include inserts for some or all of the following sizes with “in” being inches, “mm” being millimeters, and a trailing “-” indicating an intermediate size: ¼ in-, ¼in, 7 mm-, 7 mm, 8 mm-/ 5/16 in-, 8 mm / 5/16 in, 3/8 in-, 3/8 in, 10 mm-, 10 mm, 11 mm-/ 7/16 in-, 11 mm / 7/16 in, 12 mm-, 12 mm, ½in-, 13 mm-/ ½in, 13 mm, 14 mm-, 14 mm / 9/16 in-, 9/16 in, 15 mm-, 15 mm, 16 mm-/ 5/8 in-, 16 mm / 5/8 in, 17 mm-, 17 mm, 11/16 in-, 11/16 in, 19 mm-/ ⅓in-, and 19 mm / 3/4 in. As indicated by the foregoing, according to some example embodiments, an intermediate or minus size may have an inside diameter that is less the one millimeter smaller than an associated standard size.

Accordingly, the chart 300 of FIG. 5 may also be applicable to the fastener engagement recesses 1122 of extractor inserts 1100. In this regard, the chart 300 shows a listing of sizes 310 that includes a plurality of SAE and metric sizes that are considered standard. The listing also includes (between each standard size) a series of intermediate (or “half”) sizes. Column 320 shows the inner diameter at the top (or widest part) of the fastener engagement recess 1122 (i.e., proximate to the drive end 1120) for each size in millimeters, and column 322 shows the inner diameter at the bottom (or narrowest part) of the fastener engagement recess 1122 (i.e., at the drive end 1110) in millimeters. Column 330 shows the inner diameter at the top (or widest part) of the fastener engagement recess 1122 (i.e., proximate to the drive end 1120) for each size in inches, and column 332 shows the inner diameter at the bottom (or narrowest part) of the fastener engagement recess 1122 in inches. Column 340 shows the outer diameter of the body 124 of a socket and is therefore not applicable to the example embodiments of an insert and column 350 shows the length of taper of the engagement ribs 1150. Within this context, it should be appreciated that the inner diameter measures the distance between engagement ribs 1150 on opposing sides of the fastener engagement recess 1122.

FIG. 14A illustrates an open end 1300 of a combination wrench. The open end 1300 comprises a drive opening 1310 that is disposed with a female drive surface assembly 1320. FIG. 14B illustrates the extractor insert 1100 installed within the drive opening 1310 with the drive surface assembly 1114 engaged with the female drive surface assembly 1320. Additionally, the securing lip 1123 may be resting on the edge surfaces around the drive opening 1320 and the magnet 1136 (not shown) may be providing magnetic bias to hold the extractor insert 1100 in engagement with one or more surfaces of the female drive surface assembly 1320.

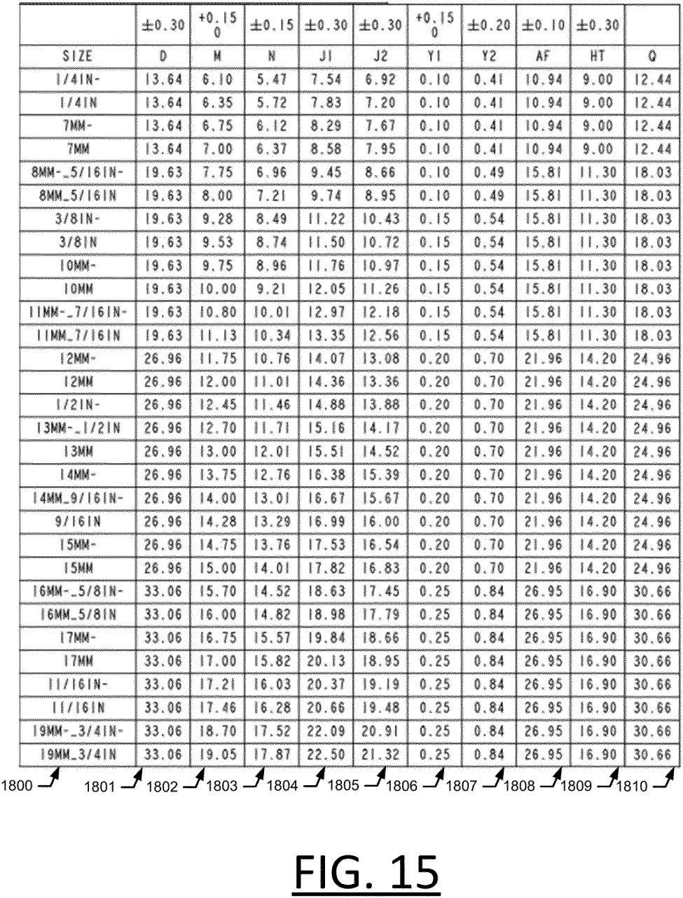

FIG. 15 illustrates a chart of size characteristics of various extractor inserts in a set of extractor inserts depicted in FIG. 12A-13, with units in millimeters, according to some example embodiments. As shown in FIG. 15, a size column 1800 defines each respective size for an intended fastener for the corresponding extractor insert. As such, the entries in the size column 1800 may define a first example set of extractor inserts. Further, subsets of the entries provided in the table of FIG. 15 may define other example sets or groups of extractor inserts. Column 1801 lists diameters of the top, drive end surface (i.e., from one edge of the securing lip to an opposite edge of the securing lip through the central axis 130 or the securing lip diameter 1140) of each corresponding extractor insert. Column 1802 indicates a maximum inside diameter (i.e., the distance between opposing engagement ribs 1150 at the drive end 1120) of the corresponding extractor insert. Column 1803 lists a minimum inside diameter (i.e., the distance between opposing engagement ribs 1150 at the driven end 1110) of the corresponding extractor insert. Column 1804 lists a diameter (i.e., the distance between opposing minima of the arc shaped grooves at the drive end 1120) of the corresponding extractor insert. Column 1805 lists a diameter (i.e., the distance between opposing minima of the arc shaped grooves at the driven end 1110) of the corresponding extractor insert. Column 1806 lists a radius of engagement rib apex at the drive end 1120 of the corresponding extractor insert. Column 1807 lists a radius of engagement rib apex at the driven end 1110 of the corresponding extractor insert. Column 1808 lists the outside hex size (drive surface assembly 1114) for the corresponding extractor insert. Column 1809 lists the height (from drive end 1120 to driven end 1110 indicated as height 1142 in FIG. 12E of the extractor insert 1100) of the corresponding extractor insert. Column 1810 lists a maximum distance across the drive surface assembly 1114 (e.g., between opposing edges of a male hex assembly) of the body 1124 of the corresponding extractor insert. It should be appreciated that the sizes and dimensions have been created after extensive research and experimentation to balance various, and often competing, performance characteristics such as strength, durability, size, access, cost, and convenience to the end user.

From the table provided in FIG. 15, various sets or groups of extractor inserts may be defined. For example, according to some example embodiments, groups of extractor inserts may be defined based on the size of the drive surface assembly 1114 as indicated by the maximum distance in column 1810. As such, the extractor inserts having a 12.44 mm maximum distance may be in a first group, extractor inserts having a 18.03 mm maximum distance may be in a second group, extractor inserts having a 24.96 mm maximum distance may be in a third group, and extractor inserts having a 30.66 mm maximum distance may be in a fourth group. Accordingly, the entire example set may require four drive tools of corresponding sizes to interface with each of the extractor inserts indicated entire example set as provided in the table of FIG. 15. Additionally, the extractor inserts in each group may have a common height as indicated by column 1809. As such, a correlation between the height of the extractor insert and the maximum distance across the drive surface assembly 1114 may be defined. Further, the first group of extractor inserts may have maximum inside diameters, as indicated in column 1802, that range from about 6.10 mm to about 7.00 mm. The second group of extractor inserts may have maximum inside diameters, as indicated in column 1802, that range from about 7.75 mm to about 11.13 mm. The third group of extractor inserts may have maximum inside diameters, as indicated in column 1802, that range from about 11.75 mm to about 15.00 mm. The fourth group of extractor inserts may have maximum inside diameters, as indicated in column 1802, that range from about 15.70 mm to about 19.05 mm.

According to some example embodiments, groups of extractor inserts may be defined based on the ranges of the maximum inside diameter provided in column 1802, where each group includes at least one minus or non-standard maximum inside diameter. Further, two member groups of extractor inserts may be defined with one extractor insert being a standard size and the other being an intermediate or minus size. According to some example embodiments, the intermediate or minus size may have a maximum inside diameter providing in column 1802 that is 0.25 mm smaller or about 0.25 mm smaller than the standard size.

In view of the foregoing, according to some example embodiments, a bidirectional extractor insert may comprise a driven end configured to receive drive power from a driving tool, a drive end configured to interface with a fastener, and a body extending between the driven end and the drive end about an axis of the insert. The drive end may comprise a fastener engagement recess extending into the body and coaxial with the body. The fastener engagement recess may comprise a plurality of engagement ribs. The engagement ribs may extend inwardly toward the axis of the insert. The engagement ribs may be tapered such that an inner diameter between two opposing ribs of the plurality of engagement ribs is largest at the drive end and decrease along at least a portion of a length of the engagement ribs extending toward the driven end. The fastener engagement recess may be configured to engage with the fastener such that the fastener is drivable in either a clockwise or a counterclockwise direction. The driven end may comprise external engaging surfaces, possibly in the form of a drive surface assembly, configured to engage with drive surfaces of the driving tool. The external engaging surfaces form a male hex assembly disposed proximate to the driven end to interface with the driving tool. The fastener engagement recess may further comprise a plurality of arc shaped grooves respective ones of which may be formed between the engagement ribs such that the arc shaped grooves also have respective lengths that extend along the axis of the insert. The arc shaped grooves may be configured to align with corner portions of the fastener to avoid contact with the corner portions of the fastener, and the corner portions may be disposed between adjacent side faces of the fastener. Additionally, a number of the engagement ribs may be equal to a number of side faces of the fastener. The engagement ribs may be disposed in pairs of opposing ribs. The insert may be configured such that a range in lengths of the inner diameter extends over a standard length between side faces of at least one standard size of fastener. Also, the at least one standard size of the fastener may be a metric standard size or a Society of Automotive Engineering (SAE) standard size. The insert may also be configured such that a range in lengths of the inner diameter does not extend over a standard length between side faces of at least one standard size of fastener, but is between two adjacent standard sizes of fastener. Each of the engagement ribs may be configured to be self-centering relative to a midpoint of a corresponding side face of the fastener responsive to insertion of the fastener into the fastener engagement recess. The engagement ribs may be substantially straight and taper inward toward the axis of the extractor socket at an angle of between 1 and 3 degrees or 1 and 5 degrees. The fastener engagement recess may be configured to engage with the fastener for removal of the fastener and subsequently engage with the fastener to reuse the fastener and achieve both a peak removal torque and a peak installation torque of greater than about 500 inch-pounds. The insert may further comprise a magnet configured to form a magnetic bias between the insert and the driving tool to maintain the insert in engagement with the driving tool. The magnet may be disposed in a recess an external engaging surface of the body. Each engagement rib may define an apex having a maximum that lies in a straight line extending the length of each engagement rib. Each apex may have a convex, circular arc shape, and a contact area formed by the convex, circular arc shape of each apex may be an only area of each engagement rib that contacts a side face of the fastener during an extraction of the fastener. Apexes of opposing engagement ribs and the axis of the insert may be disposed in a common plane.

Additionally, an example set of bidirectional extractor inserts is provided. The set of extractor inserts may comprise a first extractor insert having a first fastener engagement recess configured to receive a first standard size of fastener for bidirectional driving of the first standard size of fastener, a second extractor insert having a second fastener engagement recess configured to receive a second standard size of fastener for bidirectional driving of the second standard size of fastener, and a first intermediate extractor insert having a third fastener engagement recess configured to receive a fastener between the first and second standard sizes of fastener. The first standard size of fastener may be a first standard metric size and the second standard size of fastener is a second standard metric size. The first standard size of fastener may be a first standard Society of Automotive Engineers (SAE) size and the second standard size of fastener may be a second standard SAE size. The first standard size of fastener may be a standard Society of Automotive Engineers (SAE) size and the second standard size of fastener is a standard metric size. Each of the first, second, and third fastener engagement recesses may have corresponding tapering. A range of inner diameters of the first fastener engagement recess may be discontinuous with a range of inner diameters of the second fastener engagement recess, and a range of inner diameters of the third fastener engagement recess may be continuous from the range of inner diameters of the first fastener engagement recess and discontinuous with the range of diameters of the second fastener engagement recess.

Additionally, with respect to example embodiments of sets of extractor inserts, another example set of extractor inserts may comprise a first insert (e.g., insert 1210), a second insert (e.g., insert 1220), and an intermediate insert (e.g., insert 1215). The first insert may have a first insert fastener engagement recess configured to receive a first standard size of fastener for driving of the first standard size of fastener. The second insert may have a second insert fastener engagement recess configured to receive a second standard size of fastener for driving of the second standard size of fastener. The intermediate insert may have an intermediate insert fastener engagement recess configured to receive a fastener between the first and second standard sizes of fastener.

Further, a set of extractor inserts may include a first group of inserts (e.g., comprising inserts 1210, 1215, and 1220), a second group of inserts (e.g., comprising inserts 1230, 1235, and 1240), and a third group of inserts (e.g., comprising inserts 1250, 1255, and 1260). Each insert within the first group may have a different fastener engagement recess maximum inside diameter (e.g., referring to measurements of D3 in FIG. 12G for each insert) but a common first securing lip diameter (e.g., referring to measurements of the securing lip diameter 1140 for each insert) and a common first drive surface assembly diameter (e.g., referring to measurements of the drive surface assembly diameter 1132 for each insert). Each insert within the second group may have a different fastener engagement recess maximum inside diameter (e.g., referring to measurements of D3 in FIG. 12G for each insert) but a common second securing lip diameter (e.g., referring to measurements of the securing lip diameter 1140 for each insert) and a common second drive surface assembly diameter (e.g., referring to measurements of the drive surface assembly diameter 1132 for each insert). Each insert within the third group may have a different fastener engagement recess maximum inside diameter (e.g., referring to measurements of D3 in FIG. 12G for each insert) but a common third securing lip diameter (e.g., referring to measurements of the securing lip diameter 1140 for each insert) and a common third drive surface assembly diameter (e.g., referring to measurements of the drive surface assembly diameter 1132 for each insert). The first group of inserts may comprise the first insert, the second insert, and the intermediate insert. The common first securing lip diameter, the common second securing lip diameter, and the common third securing lip diameter may be different lengths, and the common first drive surface assembly diameter, the common second drive surface assembly diameter, and the common third drive surface assembly diameter may be different lengths. According to some example embodiments, the different fastener engagement recess maximum inside diameters for the first group may range from about 6.10 millimeters (mm) to about 7.00 mm. The different fastener engagement recess maximum inside diameters for the second group may range from about 7.75 mm to about 11.13 mm, and the different fastener engagement recess maximum inside diameters for the third group may range from about 11.75 mm to about 15.00 mm.

According to some example embodiments, each of the first, second, and intermediate insert fastener engagement recesses may have corresponding tapering, and a range of inner diameters of the first insert fastener engagement recess may be discontinuous with a range of inner diameters of the second insert fastener engagement recess. Further, a range of inner diameters of the intermediate insert fastener engagement recess may be continuous from the range of inner diameters of the first insert fastener engagement recess and discontinuous with the range of diameters of the second insert fastener engagement recess. According to some example embodiments, the first insert fastener engagement recess may be defined in part by a plurality of first engagement ribs, where opposing first engagement ribs of the plurality of first engagement ribs may define a first maximum inside diameter between the opposing first engagement ribs. The intermediate insert fastener engagement recess may be defined in part by a plurality of intermediate engagement ribs, where opposing intermediate engagement ribs of the plurality of intermediate engagement ribs may define a second maximum diameter between the intermediate opposing engagement ribs. The second maximum inside diameter is about 0.25 millimeters smaller than the first maximum inside diameter.

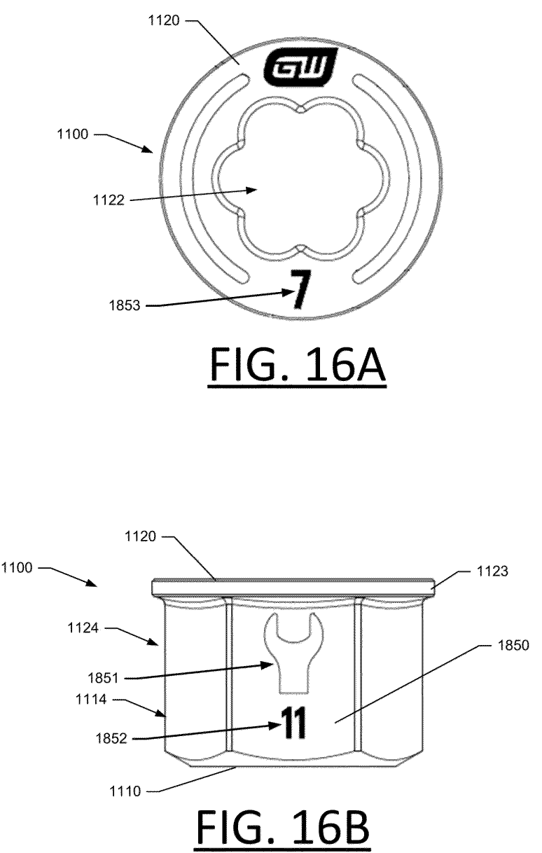

Now referencing FIGS. 16A and 16B, additional example embodiments of the extractor insert 1100 are shown with indicia or markings provided thereon. Such indicia may be etched, printed, stamped, or the like into surfaces of the extractor insert 1100. In this regard, referencing FIG. 16A, a top view of the extractor insert 1100 is provided illustrating a first indicia 1853 disposed on a top surface of the drive end 1120 of the extractor insert 1100, for example, between the fastener engagement recess 1122 and the outer edge of the securing lip 1123. The first indicia indicative of a target fastener size (e.g., “7” for 7 mm, “7-” for 6.75 mm, or “½” for ½ inch) for use with the extractor insert 1100.

Now referencing FIG. 16B, a side view of the extractor insert 1100 is provided illustrating a second indicia 1852 disposed on one of the external engaging surfaces 11850 of the drive surface assembly 1114 on the body 1124. The second indicia 1852 may be disposed between the securing lip 1123 and the driven end 1110. The second indicia indicative of a size or length of a driving tool opening between opposing drive surfaces of the driving tool (e.g., “11” for 11 mm, or “½” for ½ inch). According to some example embodiments, a third indicia 1851 may be provided as a graphic that, for example, depicts a wrench to indicate that the second indicia is referencing a length of a driving tool opening between opposing drive surfaces of a driving tool.

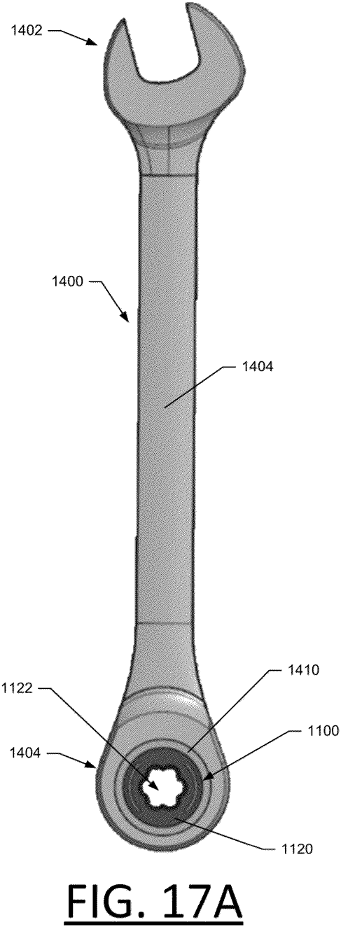

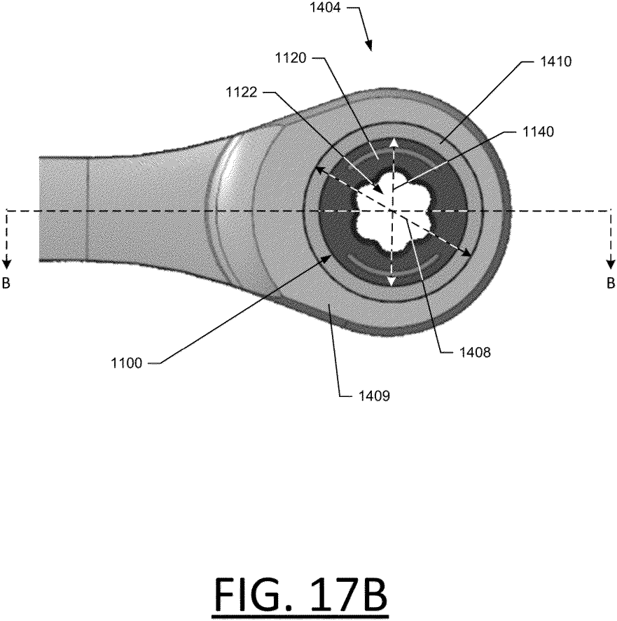

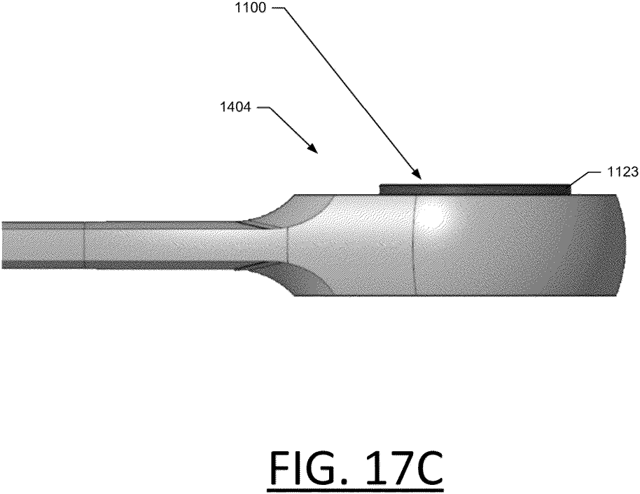

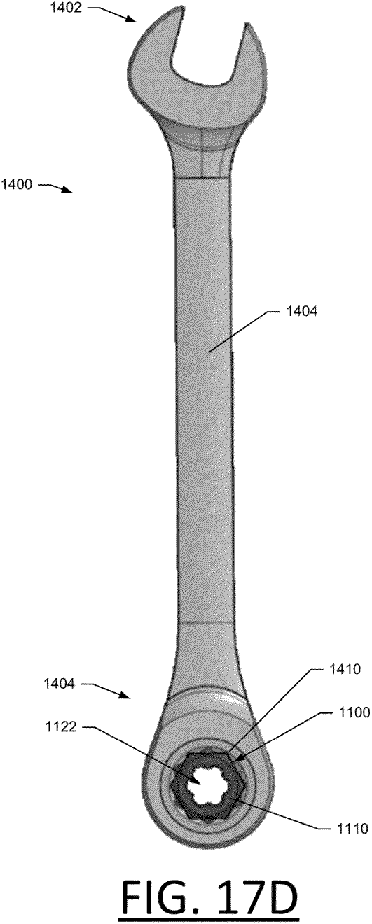

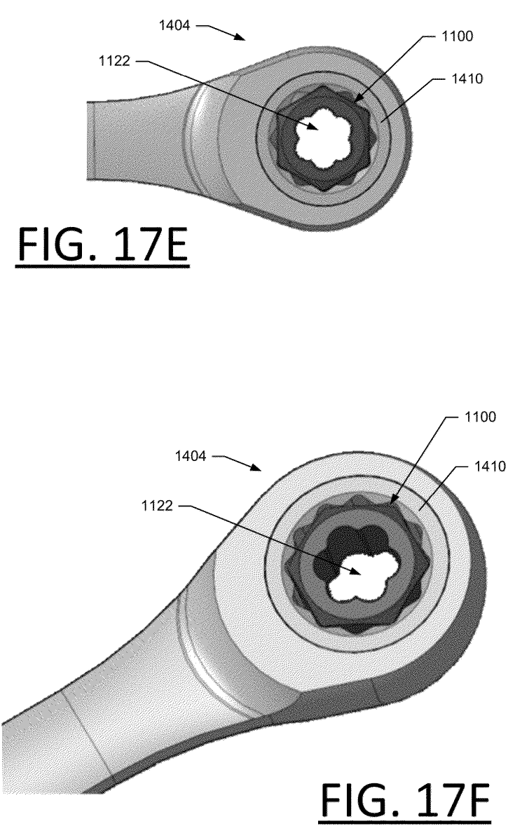

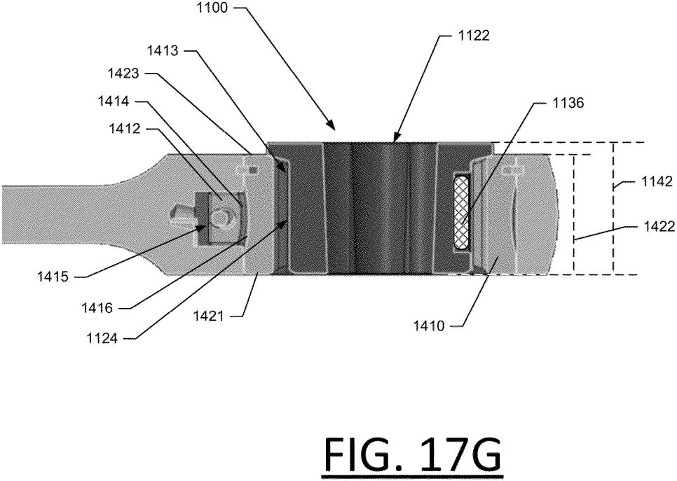

As described herein, the extractor insert 1100 may be coupled with a driving tool to from an extraction system for rotationally acting upon a fastener. According to some example embodiments, the driving tool may be wrench such as the combination wrench 1400 illustrated in whole or in part in FIGS. 17A to 17G. In FIGS. 17A to 17G, the wrench 1400 is coupled with an extractor insert 1100 by the extractor insert 1100 being disposed within a drive opening of a box wrench end 1404 of the wrench 1400. In this regard, FIG. 17A illustrates a top side view of the wrench 1400 with the extractor insert 1100 disposed in the drive opening of the box wrench end 1404. FIG. 17B illustrates zoomed top side view of the box wrench end 1404 of the wrench 1400 with the extractor insert 1100 disposed in the drive opening of the box wrench end 1404. FIG. 17C illustrates zoomed side view of the box wrench end 1404 of the wrench 1400 with the extractor insert 1100 disposed in the drive opening of the box wrench end 1404. FIG. 17D illustrates a bottom side view of the wrench 1400 with the extractor insert 1100 disposed in the drive opening of the box wrench end 1404. FIG. 17E illustrates zoomed bottom side view of the box wrench end 1404 of the wrench 1400 with the extractor insert 1100 disposed in the drive opening of the box wrench end 1404. FIG. 17F illustrates zoomed bottom side perspective view of the box wrench end 1404 of the wrench 1400 with the extractor insert 1100 disposed in the drive opening of the box wrench end 1404. FIG. 17G illustrates cross-section side view of the box wrench end 1404 of the wrench 1400 with the extractor insert 1100 disposed in the drive opening of the box wrench end 1404 taken at B-B of FIG. 17B.

The wrench 1400 may comprise an open wrench end 1402, a handle 1404, and a box wrench end 1404. According to some example embodiments, the box wrench end 1404 may comprise a ratcheting assembly configured to permit ratcheting movement in a first rotational direction and a driving torque in a second rotational direction. The ratcheting assembly may comprise a ratchet ring 1410 that defines a drive opening in a central void for the box wrench end 1404. The ratchet ring 1410 may be disposed within a void in the box wrench end 1404 and be rotatable relative to the box wrench end 1404 when rotating in a ratcheting direction. While a portion of the ratchet ring 1410 may be concealed within the box wrench end 1404, an interior rim of the ratchet ring 1410 may be exposed on the top side and bottom side of the box wrench end 1404.

In FIGS. 17A to 17G, the extractor insert 1100 may be removably coupled with the wrench 1400 to form an extractor system. More specifically, the extractor insert 1100 may be coupled with a drive opening in the box wrench end 1404 of the wrench 1400. With reference to FIG. 17B, the diameter 1408 of the void in the box wrench end 1404 that houses the ratchet ring 1410 is shown. It can be seen that, according to some example embodiments, the securing lip width 1140 is smaller than the diameter 1408 such that the extractor insert 1100, and the securing lip 1123 of the extractor insert 1100, only come into direct contact with the ratchet ring 1410. As such, the extractor insert 1100 and the ratchet ring 1410 rotate as a unit and there is no relative rotation between the ratchet ring 1410 and the extractor insert 1100. However, both the ratchet ring 1410 and the extractor insert 1100 may rotate relative to the housing 1409 of the box wrench end 1404. If the securing lip 1123 extended to come into physical contact with the housing 1409, then rotation of the extractor insert 1100 would cause rubbing and friction between the extractor insert 1100 and the housing 1409. Therefore, to avoid this detriment, example embodiments of the extractor insert 1100 have a securing lip 1123 that overlaps the ratchet ring 1410, but does not overlap or otherwise come into physical contact with the housing 1409 of the box wrench end 1404. Accordingly, a portion of the ratchet ring 1410 may be exposed on the top side and bottom side of the wrench 1400 such that a extractor insert engaging edge of the drive opening is part of the ratchet ring 1410. The securing lip 1123 of the extractor insert 1100 may therefore radially extend over the extractor insert engaging edge and the ratchet ring 1410, but does not extend over the housing of the wrench head (e.g., the box wrench end 1404).

Referring to FIG. 17C, the securing lip 1123 of the extractor insert 1100 can be seen extending above a top surface of the box wrench end 1404. However, according to some example embodiments, no other portion of the extractor insert 1100 is visible in this side view. This is because, according to some example embodiments, the height 1142 of the extractor insert 1100 is defined such that the portion of the body 1124 of the extractor insert 1100 that extends into the drive opening of the box wrench end 1404 is less than the height of the drive opening. As a result, the extractor insert 1100 does not extend beyond the bottom surface of the box wrench end 1404. By sizing the extractor insert 1100 in this manner, the inclusion of the extractor insert 1100 in the drive opening of the box wrench end 1404 does not create a significant clearance issue due to protruding portions of the extractor insert 1100. Accordingly, the height of the extractor insert 1100 is small relative to the width of the extractor insert 1100. In this regard, the width 1140 of the securing lip 1123 through the central axis 1130 may be larger than a height 1142 of the extractor insert 1100. As such, the securing lip 1123 may operate as a catch on a top or extractor insert engaging edge of the drive opening of the drive tool (e.g., wrench 1400). Further, the driven end 1110 of the extractor insert 1100 may not extend beyond a bottom edge of the drive opening of the wrench 1400.

Now with reference to FIG. 17G, the cross-section view of the extractor system is shown. In this regard, additional components of the ratcheting assembly are shown in the form of a biased ratchet pawl 1412 with pawl teeth 1414. The ratchet pawl 1412 may be disposed in a cavity 1415 and adjacent to the ratchet ring 1410, which may comprise ring teeth 1416. The ratchet ring 1410 may also comprise a top ratchet ring edge 1423 that is exposed on the top side of the wrench 1400 and a bottom ratchet ring edge 1421 this is exposed on a bottom side of the wrench 1400. As seen in FIG. 17G, the securing lip 1123 may rest on either top ratchet ring edge 1423 or the bottom ratchet ring edge 1421. In this regard, according to some example embodiments, the top ratchet ring edge 1423 and the bottom ratchet ring edge 1421 may have an angled or chamfered surface that corresponds to a lip angle 1139 of the extractor insert 1100 at a contact point between the extractor insert 1100 and the ratchet ring 1410.

The drive opening of the box wrench end 1404 may extend from the top surface to the bottom surface of the box wrench end 1404 and define a drive opening height 1422. The portion of the body 1124 disposed within drive opening 1413 may extends into the drive opening a distance that is less than the opening height 1422. As such, the body 1124 does not extend beyond the bottom side surface of the box wrench end 1404 when the securing lip 1123 is rested on an edge 1423 or 1421 of the ratchet ring 1410.

As mentioned above, the extractor insert 1100 may be removably engaged with the drive opening of the wrench 1400 such that a portion of the body 1124 of the extractor insert 1100 is disposed within the drive opening and the securing lip 1123 rests on an edge 1423 of the drive opening 1413 of the wrench 1400. As such, the securing lip 1123 may operate to prevents the extractor insert 1100 from falling from a drive tool (e.g., the wrench 1400) in a first falling direction (i.e., downwards through the drive opening 1413) and the magnet 1136, in magnetic engagement with the ratchet ring 1410, may prevent the extractor insert 1100 from falling from the drive tool (e.g., wrench 1400) in a second falling direction (i.e., upwards and out of the drive opening 1413) that is opposite the first falling direction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A extractor insert having a driven end and a drive end, the extractor insert comprising:
a body extending along a central axis of the extractor insert and comprising a fastener engagement recess and a drive surface assembly; and
a securing lip coupled to the body at the driven end, the securing lip extending radially away from the central axis such that the securing lip extends beyond an exterior of the body;
wherein the drive surface assembly comprises a plurality of external engaging surfaces configured to interface with a driving tool to permit a rotational force to be applied to the extractor insert;
wherein the fastener engagement recess is an internal channel through the body extending along the central axis that is open at the driven end and the drive end, the fastener engagement recess being defined by internal sidewalls of the body;
wherein a plurality of engagement ribs extend from the internal sidewalls of the body towards the central axis, each engagement rib comprising an apex that extends along a length of the engagement rib, each engagement rib having an opposing engagement rib such that apexes of opposing engagement ribs are disposed on a common plane with the central axis;
wherein each apex tapers at a taper angle relative to the central axis such that a distance between apexes of opposing engagement ribs is largest at the drive end and smallest at the driven end.

2. The extractor insert of claim 1, wherein the plurality of external engaging surfaces of the of the drive surface assembly form a male hex assembly for engaging with a drive tool having a female hex assembly;
wherein a maximum width across the male hex assembly through the central axis is larger than a height of the extractor insert to limit a depth that the extractor insert extends into the drive opening of the drive tool.

3. The extractor insert of claim 1, wherein the plurality of external engaging surfaces of the of the drive surface assembly form a male hex assembly for engaging with a drive tool having a female hex assembly;
wherein a width of the securing lip through the central axis is larger than a maximum width across the male hex assembly through the central axis such that the securing lip operates as a catch on a top edge of a drive opening of the drive tool.

4. The extractor insert of claim 1, wherein a width of the securing lip through the central axis is larger than a height of the extractor insert such that the securing lip operates as a catch on a top edge of a drive opening of a drive tool that is a wrench and the driven end of the extractor insert does not extend beyond a bottom edge of the drive opening of the wrench.

5. The extractor insert of claim 1, wherein the taper angle is between 1 and 3 degrees or 1 and 5 degrees.

6. The extractor insert of claim 1, wherein edges of the drive surface assembly where each external engaging surface meets an adjacent external engaging surface are chamfered or rounded.

7. The extractor insert of claim 1 further comprising a magnet configured to form a magnetic bias between the insert and the driving tool to maintain the insert in engagement with the driving tool;
wherein the securing lip prevents the extractor insert from falling from a drive tool in a first falling direction and the magnet prevents the extractor insert from falling from the drive tool in a second falling direction that is opposite the first falling direction.

8. The extractor insert of claim 7, wherein the magnet is disposed in a magnet recess in an external engaging surface of the drive surface assembly.

9. The extractor insert of claim 8, wherein a depth of the magnet recess is less than half of a thickness of the body between the internal sidewall and the external engaging surface at the magnet recess for torque strength at the magnet recess.

10. The extractor insert of claim 1, wherein an underside of the securing lip extends to the body at lip angle of greater than 5 degrees.

11. The extractor insert of claim 1 further comprising a first indicia indicative of a fastener size for use with the extractor insert disposed on a surface at the drive end of the extractor insert.

12. The extractor insert of claim 11 further comprising a second indicia indicative of a size of driving tool opening for use the extractor insert disposed on one of the external engaging surfaces of the drive surface assembly.

13. A set of extractor inserts comprising:
a first insert having a first insert fastener engagement recess configured to receive a first standard size of fastener for driving of the first standard size of fastener;
a second insert having a second insert fastener engagement recess configured to receive a second standard size of fastener for driving of the second standard size of fastener; and
an intermediate insert having an intermediate insert fastener engagement recess configured to receive a fastener between the first and second standard sizes of fastener.

14. The set of extractor inserts of claim 13 comprises:
a first group of inserts with each insert within the first group having a different fastener engagement recess maximum inside diameter but a common first securing lip diameter and a common first drive surface assembly diameter;
a second group of inserts with each insert within the second group having a different fastener engagement recess maximum inside diameter but a common second securing lip diameter and a common second drive surface assembly diameter; and
a third group of inserts with each insert within the third group having a different fastener engagement recess maximum inside diameter but a common third securing lip diameter and a common third drive surface assembly diameter;
wherein the first group of inserts comprises the first insert, the second insert, and the intermediate insert;
wherein the common first securing lip diameter, the common second securing lip diameter, and the common third securing lip diameter are different lengths;
wherein the common first drive surface assembly diameter, the common second drive surface assembly diameter, and the common third drive surface assembly diameter are different lengths.

15. The set of extractor inserts of claim 14, wherein the different fastener engagement recess maximum inside diameters for the first group range from about 6.10 millimeters (mm) to about 7.00 mm;
wherein the different fastener engagement recess maximum inside diameters for the second group range from about 7.75 mm to about 11.13 mm; and
wherein the different fastener engagement recess maximum inside diameters for the third group range from about 11.75 mm to about 15.00 mm.

16. The set of extractor inserts of claim 13, wherein each of the first, second, and intermediate insert fastener engagement recesses have corresponding tapering;
wherein a range of inner diameters of the first insert fastener engagement recess is discontinuous with a range of inner diameters of the second insert fastener engagement recess;
wherein a range of inner diameters of the intermediate insert fastener engagement recess is continuous from the range of inner diameters of the first insert fastener engagement recess and discontinuous with the range of diameters of the second insert fastener engagement recess.

17. The set of extractor inserts of claim 13, wherein the first insert fastener engagement recess is defined in part by a plurality of first engagement ribs, wherein opposing first engagement ribs of the plurality of first engagement ribs define a first maximum inside diameter between the opposing first engagement ribs;
wherein the intermediate insert fastener engagement recess is defined in part by a plurality of intermediate engagement ribs, wherein opposing intermediate engagement ribs of the plurality of intermediate engagement ribs define a second maximum inside diameter between the intermediate opposing engagement ribs;
wherein the second maximum inside diameter is about 0.25 millimeters smaller than the first maximum inside diameter.

18. An extraction system comprising:
a wrench comprising a drive opening having an opening height defined by a top side and a bottom side of the wrench and an opening width; and
an extractor insert comprising:
a body comprising a fastener engagement recess that extends through the body, the body and the fastener engagement recess extending along a central axis from a drive end that receives a fastener into the fastener engagement recess to a driven end of the extractor insert; and
a securing lip radially extending away from the body and away from the central axis at the drive end;
wherein a plurality of tapered engagement ribs extend into the fastener engagement recess from internal sidewalls of the body towards the central axis, each tapered engagement rib comprising an apex that extends along a length of the tapered engagement rib, each tapered engagement rib having an opposing tapered engagement rib such that apexes of the opposing tapered engagement ribs are disposed on a common plane with the central axis;
wherein the securing lip defines a securing lip width through the central axis and the body defines a body width through the central axis, the securing lip width being larger than the body width;
wherein the extractor insert is removably engaged with the drive opening of the wrench such that a portion of the body of the extractor insert is disposed within the drive opening and the securing lip rests on an extractor insert engaging edge of the drive opening on the top side of the wrench;
wherein the portion of the body disposed within drive opening extends into the drive opening a distance that is less than the opening height such that the body does not extend beyond the bottom side of the wrench when the securing lip is rested on the top edge of the drive opening.

19. The extraction system of claim 18 wherein the wrench comprises a ratchet mechanism and the ratchet mechanism comprises a ratchet ring that rotatable relative to a wrench head, wherein the drive opening is disposed within a central void of the ratchet ring and a portion of the ratchet ring is exposed on the top side and bottom side of the wrench such that the top edge of the drive opening is on the ratchet ring;
wherein the securing lip of the extractor insert radially extends over the top edge and the ratchet ring, but does not extend over the wrench head.

20. The extraction system of claim 19 wherein an underside of the securing lip extends to the body at lip angle of greater than 5 degrees;
wherein the top edge of the ratchet ring is chamfered to correspond to the lip angle of the securing lip.
